(19) United States
(12) Patent Application Publication
(10) Pub. No.: US 2021/0003758 A1
(43) Pub. Date: Jan. 7, 2021

(54) CIRCULAR POLARIZER, AND NOTCH FILTER AND BAND-PASS FILTER COMPRISING SAME

(71) Applicant: INDUSTRY-ACADEMIC COOPERATION FOUNDATION GYEONGSANG NATIONAL UNIVERSITY, Gyeongsangnam-do (KR)

(72) Inventor: MI-YUN JEONG, Gyeongsangnam-do (KR)

(21) Appl. No.: 16/630,190

(22) PCT Filed: Jun. 22, 2018
(86) PCT No.: PCT/KR2018/007064

§ 371 Date: Jan. 10, 2020

(30) Foreign Application Priority Data
Jul. 11, 2017 (KR) 10-2017-0087744
Dec. 19, 2017 (KR) 10-2017-0175452

(51) Int. Cl. G02B 5/30; G02B 27/28

(52) U.S. Cl. CPC G02B 5/3016; G02B 1/11; G02B 27/283; G02B 27/288

(57) ABSTRACT

A circular polarizer, a notch filter and a band-pass filter comprising the same are disclosed. The circular polarizer includes: a pair of substrates, a polyimide PI layer which is coated on one side of each of the pair of the substrates, a plurality of spacers disposed to ensure a space between the polyimide PI layer which is coated on one side of each of the pair of the substrates, and cholesteric liquid crystals CLC disposed in the space ensured by the spacers and including any one of a levorotatory chiral material or a dextrorotary chiral material of a predetermined concentration.

### 1. FIELD

The present disclosure relates to a circular polarizer, a notch filter and a bandpass filter including the same, and more particularly, to a circular polarizer which doesn't require a phase retarder and a notch filter and a bandpass filter using a circular polarizer.

### 2. DESCRIPTION OF RELATED ART

Light is electromagnetic waves that travel while the intensity of the electric and magnetic fields vary periodically. Natural light is electromagnetic waves whose intensity of the electric field varies periodically in all directions of 360 degrees. Among the components of natural light, it has polarization characteristics by the direction of the electric field in any plane perpendicular to the traveling direction.

Types of polarization include linear polarization, circular polarization, and elliptical polarization. Circular polarization includes left-hand circular polarization in which the direction of the electric field of light rotates counterclockwise and right-hand circular polarization in which the direction of the electric field of light rotates clockwise. Linear polarization is the sum of right-hand and left-hand circular polarization. The polarization characteristics of light are used for an optical device or a display device, etc.

On the other hand, generally, circularly polarized light can be obtained by passing the linearly polarized light passed through the linear polarizer through the phase retarder. However, the phase retarder is expensive, and in order to use the phase retarder, an optical knowledge is required because optical axis of the polarizer and the phase retarder have to be aligned with each other, and it can be used for only one wavelength, and if the wavelength changes, another phase retarder has to be used.

Accordingly, there is a need for a circular polarizer and a filter using a circular polarizer which are capable of obtaining circularly polarized light for multiple wavelengths with one device without using multiple phase retarders.

### Solution to Problem

The following description provides a circular polarizer capable of easily obtaining circularly polarized light for multiple wavelengths with one device, without using a phase retarder.

Further, the following description provides a notch filter and a bandpass filter using some circular polarizers.

Also the following description provides a notch filter and a bandpass filter having excellent characteristics despite an input of a high energy laser light source.

### SUMMARY

Circular polarizer according to an example includes a pair of substrates, a polyimide PI layer coated on one surface of each of the pair of the substrates, a plurality of spacers disposed to secure a space between the polyimide PI layers coated on one surface of each of the pair of the substrates, and a cholesteric liquid crystal CLC layer disposed on the space secured by the spacers and includes any one of the chiral material of a predetermined concentration of a levorotatory chiral material or a dextrorotatory chiral material.

And at least one substrate of the pair of the substrates may be non-reflective coated on the other surface.

In addition, the sizes of the plurality of spacers are different from each other.

In addition, the cholesteric liquid crystal layer may include azo dyes of a predetermined concentration which is photoisomerized by ultraviolet rays UV

In addition, the cholesteric liquid crystal layer is emitted with uniform ultraviolet rays through an ND filter continuously varying the light transmittance depending on the predetermined direction, and continuously varies in the proportion of photoisomerized azo dyes based on the intensity of transmitted ultraviolet rays corresponding to the light transmittance of the ND filter or the intensity of ultraviolet rays transmitted by being emitted by ultraviolet rays of different intensity depending on the predetermined direction.

The cholesteric liquid crystal layer may include the azo dyes having a concentration gradient continuously varying in a predetermined direction, and wherein the azo dyes are photoisomerized by ultraviolet rays having a uniform intensity.

The cholesteric liquid crystal layer may include the chiral material having a concentration gradient continuously varying in a predetermined direction.

On the other hand, the circular polarizer includes a heater supplying heat of a first temperature through one end of any one of the pair of the substrates, and supplying heat of a second temperature which is lower than the first temperature through the other end of any one of the substrates, and wherein the pitch of the cholesteric liquid crystal layer varies by the temperature gradient by the supplied heat of the first temperature and the supplied heat of the second temperature.

Meanwhile, the circular polarizer may further include a rotator for disposing the circular polarizer at a location spaced apart by a predetermined distance from a rotation axis and for rotating the circular polarizer, in order to continuously implement a tunable wavelength circular polarizer.

And, the circular polarizer further includes a heater supplying heat of a predetermined temperature through one end of at least one of the pair of the substrates, and wherein the pitch of the cholesteric liquid crystal layer varies corresponding to the supplied heat.

In addition, the circular polarizer may further include a power supply for supplying a voltage through the pair of the substrates, and wherein the pitch of the cholesteric liquid crystal layer varies corresponding to the supplied voltage.

In addition, a notch filter according to an example includes a right-hand circular polarizer including a cholesteric liquid crystal CLC layer including a levorotatory chiral material of a predetermined concentration to reflect light of a left-hand circular component of a predetermined frequency band among the light output from a light source, and a left-hand circular polarizer including a cholesteric liquid crystal CLC layer including a dextrorotatory chiral material of a predetermined concentration to reflect light of a right-hand circular component of the predetermined frequency band among the light passed through the right-hand circular polarizer.

In addition, a notch filter according to another example includes a pair of substrates, a polyimide PI layer coated on one surface of each of the pair of the substrates, an anti-reflective layer coated on the other surface of each of the pair of the substrates, a plurality of first and second spacers disposed to secure space between the polyimide PI layer, a first cholesteric liquid crystal CLC layer which is disposed on the space secured by the first spacer and having right-hand circular polarization characteristics of including a levorotatory chiral material of a predetermined concentration to reflect light of a left-hand circular component of a predetermined frequency band and to transmit light of a right-hand circular component among the light output from a light source, and a second cholesteric liquid crystal CLC layer which is disposed on the space secured by the second spacer and having left-hand circular polarization characteristics of including a dextrorotatory chiral material of a predetermined concentration to reflect light of a right-hand circular component of a predetermined frequency band and to transmit light of a left-hand circular component among the light output from a light source.

On the other hand, a notch filter according to another example includes a substrate, a polyimide PI layer coated on one surface of the substrate, a first cholesteric liquid crystal layer CLC spin-coated on the polyimide layer, having right-hand circular polarization characteristics, including a levorotatory chiral material of a predetermined concentration to reflect light of a left-hand circular component of a predetermined frequency band among the light output from a light source, and a second cholesteric liquid crystal layer CLC spin-coated on the first cholesteric liquid crystal layer, having left-hand circular polarization characteristics and including a dextrorotatory chiral material of a predetermined concentration to reflect light of a right-hand circular component of a predetermined frequency band among light output from a light source.

In addition, a bandpass filter according to an example includes a beam splitter for transmitting the light output from a light source, and a circular polarizer including one of a right-hand circular polarizer including a cholesteric liquid crystal CLC layer including a levorotatory chiral material of a predetermined concentration to reflect light of left-hand circular component of a predetermined frequency band among light passed through the beam splitter, or a left-hand circular polarizer including a cholesteric liquid crystal CLC layer including a dextrorotatory chiral material of a predetermined concentration to reflect light of right-hand circular component of a predetermined frequency band among the light passed through the beam splitter, and wherein the beam splitter reflects the light of the left-hand circular component of the predetermined frequency band reflected by the circular polarizer to convert into light of the right-hand circular component, or reflect the light of the right-hand circular component of the predetermined frequency band reflected by the circular polarizer to convert into light of the left-hand circular component.

A filter according to an example includes a plurality of right-hand circular polarizers including a cholesteric liquid crystal CLC layer including a levorotatory chiral material of a predetermined concentration, and a plurality of left-hand circular polarizers including a cholesteric liquid crystal CLC layer including a dextrorotatory chiral material of a predetermined concentration, and the plurality of right-hand circular polarizers and left-hand circular polarizers are alternately placed, and wherein the surfaces of the right-hand circular polarizers and the left-hand circular polarizers which are exposed to the outside are anti-reflective coated.

A filter according to another example includes a plurality of right-hand circular polarizers including a cholesteric liquid crystal CLC layer including a levorotatory chiral material of a predetermined concentration, a plurality of left-hand circular polarizers including a cholesteric liquid crystal CLC layer including a dextrorotatory chiral material of a predetermined concentration, and an index matching material layer disposed between the plurality of right-hand circular polarizers and the left-hand circular polarizers, and wherein the plurality of right-hand circular polarizers and left-hand circular polarizers are alternately placed, and wherein the surfaces of the right-hand circular polarizers and the left-hand circular polarizers which are exposed to the outside are anti-reflective coated.

And wherein the plurality of right-hand circular polarizers blocks light of a left-hand circular component of a predetermined frequency band among the light incident on the surface at a predetermined first angle, and wherein the plurality of left-hand circular polarizer blocks light of a right-hand circular component of a predetermined frequency band among the light incident on the surface at a predetermined first angle and transmits light except for the blocked light of a left-hand circular component and of a right-hand circular component.

In addition, wherein the plurality of right-hand circular polarizers reflects light of a left-hand circular component of a predetermined frequency band among the light incident on the surface at a predetermined second angle, wherein the plurality of left-hand circular polarizers reflects light of a right-hand circular component of a predetermined frequency band among the light incident on the surface at a predetermined second angle.

### Effects of Invention

According to various examples described above, the circular polarizer may obtain circularly polarized light without a phase retarder.

And, the user may use a cheap and simple circular polarizer.

According to various examples, circularly polarized light may be obtained from all wavelengths in a predetermined wavelength region (photonic band gap, PBG) with one circular polarizer.

According to various examples, a notch filter and a bandpass filter using a circular polarizer may be used.

According to various examples, a notch filter and a bandpass filter using some circular polarizers may perform a tunable wavelength filter function for various wavelengths.

Meanwhile, according to various examples, a bandpass filter may be implemented without a beam splitter.

In addition, according to various examples, a notch filter and a bandpass filter using some circular polarizers may have excellent characteristics despite an input of a high energy laser light source.

### BRIEF DESCRIPTION OF THE DRAWINGS

FIG. 1 illustrates the structure of a circular polarizer according to an example.

FIGS. 2(a) and 2(b) illustrate a right-hand circular polarizer and a left-hand circular polarizer according to an example.

FIG. 3 illustrates a circular polarizer including spacers of different sizes according to an example.

FIG. 4 illustrates a circular polarizer using a concentration difference of a chiral material according to an example.

FIG. 5 illustrates photoisomerization of azo dyes.

FIG. 6 illustrates a circular polarizer using azo dyes according to an example.

FIG. 7 illustrates a circular polarizer using the concentration difference of the azo dyes according to an example.

FIG. 8 illustrates a circular polarizer using azo dyes and an ND filter according to an example.

FIG. 9 illustrates a circular polarizer using heat according to an example.

FIG. 10 illustrates a circular polarizer using a temperature gradient according to an example.

FIG. 11 illustrates a circular polarizer using an electric field according to an example.

FIG. 12 illustrates a circular polarizer using a rotator according to an example.

FIGS. 13 to 19 illustrate a notch filter according to various examples.

FIGS. 20 and 21 illustrate a method of implementing a notch filter according to another example.

FIGS. 22 and 23 illustrate a notch filter according to another example.

FIG. 24 illustrates an output waveform of a notch filter according to an example.

FIGS. 25 to 38 illustrate a bandpass filter according to various examples.

FIG. 39 illustrates an output waveform of a bandpass filter according to an example.

FIGS. 40 and 43 illustrate a method of implementing a filter including a plurality of cholesteric liquid crystals according to an example.

FIGS. 44 to 45 illustrate a structure of a filter including a plurality of cholesteric liquid crystal layers according to an example.

FIGS. 46 to 48 illustrate a notch filter including a plurality of cholesteric liquid crystal layers according to an example.

FIGS. 49 to 54 illustrate a bandpass filter including a plurality of cholesteric liquid crystal layers according to an example.

FIG. 55 illustrates a composite filter including a bandpass filter and a notch filter according to an example.

FIG. 56 illustrates an output waveform of a filter according to an example.

### DETAILED DESCRIPTION

Hereinafter, various examples will be described in more detail with reference to the accompanying drawings. Examples described herein may be variously modified. Specific examples are depicted in the drawings and may be described in detail in the detailed description. However, the specific examples disclosed in the accompanying drawings are only for easy understanding of the various examples. Therefore, the technical spirit is not limited by the specific examples disclosed in the accompanying drawings, and it should be understood to include all equivalents or substitutes included in the spirit and scope of the disclosure.

Terms including ordinal numbers such as first and second may be used to describe various components, but these components are not limited by the terms described above. The terms described above are used only for the purpose of distinguishing one component from another.

The terms “comprises,” “includes,” and “has” specify the presence of stated features, numbers, operations, members, elements, and/or combinations thereof, but do not preclude the presence or addition of one or more other features, numbers, operations, members, elements, and/or combinations thereof. Throughout the specification, when an element, such as a layer, region, or substrate, is described as being “on,” “connected to,” or “coupled to” another element, it may be directly “on,” “connected to,” or “coupled to” the other element, or there may be one or more other elements intervening therebetween. In contrast, when an element is described as being “directly on,” “directly connected to,” or “directly coupled to” another element, there can be no other elements intervening therebetween.

On the other hand, “module” or “unit” for the components used herein performs at least one function or operation. The module or unit may perform a function or an operation by hardware, software, or a combination of hardware and software. In addition, a plurality of “modules” or a plurality of “parts” other than a “module” or a “part” to be executed in specific hardware or performed in at least one processor may be integrated into at least one module. Singular expressions include plural expressions unless the context clearly indicates otherwise.

In addition, in describing the present disclosure, when it is determined that a detailed description of a related known function or configuration may unnecessarily obscure the subject matter of the present disclosure, the detailed description thereof will be abbreviated or omitted. Meanwhile, although each example may be independently implemented or operated, each example may be implemented or operated in combination.

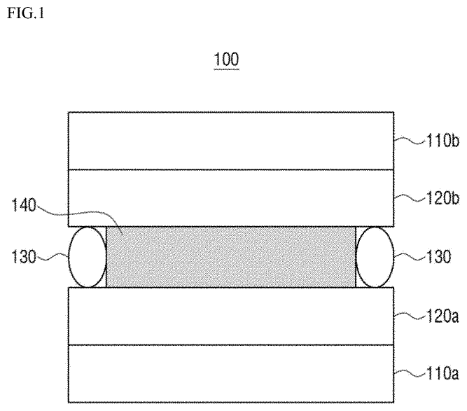

FIG. 1 illustrates a structure of a circular polarizer according to an example.

Referring to FIG. 1, the circular polarizer 100 includes substrates 110a, 110b, polyimide layers PI 120a, 120b, a spacer 130 and a cholesteric liquid crystal CLC 140. 110a and 110b substrates may be made of glass or glass coated with indium tin oxide (ITO).

First, a pair of substrates 110a, 110b is prepared. For example, the substrates 110a and 110b may be made of glass, glass coated with ITO (Indium Tin Oxide), or plastic, and if necessary, the substrate may be used as anti-reflective coated on one or both sides to the incident light. Polyimide layers 120a and 120b are coated on one surface of each of the pair of the substrates 110a and 110b. Polyimides do not vary material properties over a wide range of temperatures and include characteristics such as high heat resistance, electrical insulation, flexibility, and nonflammability. For example, the polyimide may be Kapton made from the condensation of pyromellitic dianhydride with 4,4′-oxydianiline. The polyimide may be classified into aliphatic compounds, semi-aromatic compounds, and aromatic compounds depending on the configuration of the linking ring. The rubbing process may be performed to the polyimide layers 120a and 120b if necessary.

The plurality of spacers 130 is disposed to secure a space between the polyimide layers 120a and 120b. That is, after the polyimide layers 120a and 120b are coated on one surface of each of the pair of the substrates 110a and 110b, the polyimide layers 120a and 120b are disposed to face each other. In addition, a spacer 130 for securing a space between the polyimide layers 120a and 120b facing each other is disposed.

The cholesteric liquid crystal 140 is disposed between the spacers 130. The cholesteric liquid crystal 140 includes a nematic liquid crystal in the form of a rod and a chiral material of a predetermined concentration. A Chiral material includes a levorotatory chiral material that reflect left-hand circularly polarized light and a dextrorotatory chiral material that reflect right-hand circularly polarized light. That is, when a levorotatory chiral material is added to the cholesteric liquid crystal 140, the nematic liquid crystals are disposed in a helical in a counterclockwise direction. In addition, when a dextrorotatory chiral material is added to the cholesteric liquid crystal 140, the nematic liquid crystals are disposed in a helical in a clockwise direction. Characteristics of the right-hand and left-hand circular polarizer will be described afterward.

The circular polarizer 100 may be manufactured by filling a cholesteric liquid crystal 140 including a chiral material having one characteristics, in a wedge or parallel cell. That is, the cholesteric liquid crystal 140 is a mixture of nematic liquid crystal and chiral material and has a spontaneous assembly helical structure. Selective reflection occurs in a specific wavelength region with respect to circularly polarized light such as the rotational helical direction of the cholesteric liquid crystal 140. This reflection is called Bragg reflection, where the center wavelength is λ_{B}=n×p and the bandwidth is Δλ=p×Δn, where p is a pitch (distance progressed when a helical structure of a cholesteric liquid crystal is rotated in 360 degrees), n is an average refractive index, Δn=ne−no is the birefringence characteristics of the nematic liquid crystal which is the difference between the extraordinary refractive index (ne) and ordinary refractive index (no) of the molecule. Therefore, the cholesteric liquid crystal 140 operates as a circular polarizer in the wavelength region which is photonic band gap PBG where Bragg reflection occurs. In addition, the reflected wavelength band of the circular polarizer 100 may be adjusted depending on the concentration of the chiral material. The circular polarization range PBG of the circular polarizer 100 may be adjusted by varying the difference (Δn=nₑ−nₒ) between the extraordinary refractive index (nₑ) and the ordinary refractive index (nₒ) of the nematic liquid crystal molecules. The circular polarizer 100 according to the present disclosure may be used in ultraviolet UV, visible light VIS, or infrared IR bands depending on the concentration of the chiral material. In some cases, the circular polarizer 100 may use not only nematic liquid crystals but also smectic liquid crystals and helical structured inorganic materials.

On the other hand, the cholesteric liquid crystal 140 may include a normal liquid crystal and all of the liquid crystal that can be polymerized by ultraviolet rays or heat. The cholesteric liquid crystal that can be polymerized by ultraviolet or heat may be manufactured through a spin-coating process.

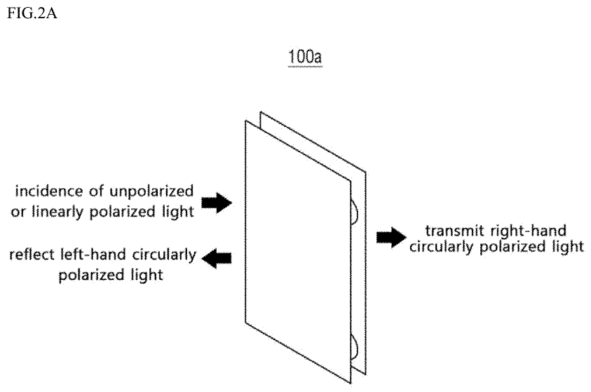

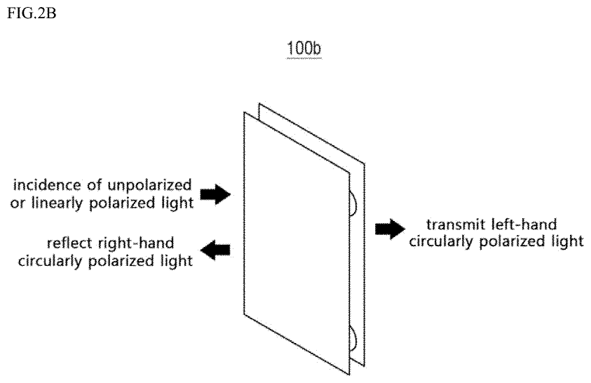

FIGS. 2(a) and 2(b) illustrate a right-hand circular polarizer and a left-hand circular polarizer according to an example.

Referring to FIG. 2(a), a right-hand circular polarizer 100a is disclosed. The cholesteric liquid crystal of the right-hand circular polarizer 100a includes a levorotatory chiral material. The cholesteric liquid crystal molecules are disposed in a counterclockwise helical by means of the levorotatory chiral material. And, the cholesteric liquid crystal including a levorotatory chiral material reflects the left-hand circularly polarized light. When the circular polarizer includes a cholesteric liquid crystal including a levorotatory chiral material, the circular polarizer may operate as a right-hand circular polarizer 100a that reflects left-hand circularly polarized light. For example, the levorotatory chiral material may be an S-811 chiral dopant mixture.

That is, when unpolarized light or linearly polarized light is incident on the right-hand circular polarizer 100a, the right-hand circular polarizer 100a reflects the left-hand circularly polarized light within a predetermined wavelength range and transmits the right-hand circularly polarized light. In various examples of the circular polarizer described below, the cholesteric liquid crystal may include a levorotatory chiral material. In addition, the circular polarizer including the levorotatory chiral material may operate as the right-hand circular polarizer 100a.

Referring to FIG. 2(b), the left-hand circular polarizer 100b is disclosed. The cholesteric liquid crystal of the left-hand circular polarizer 100b includes a dextrorotatory chiral material. The cholesteric liquid crystal molecules are disposed in a clockwise helical by the dextrorotatory chiral material. And, the cholesteric liquid crystal including the dextrorotatory chiral material reflects right-hand circularly polarized light. When the circular polarizer includes a cholesteric liquid crystal including a dextrorotatory chiral material, the circular polarizer may operate as a left-hand circular polarizer 100b which reflects right-hand circularly polarized light. For example, the dextrorotatory chiral material may be an R-811 chiral dopant mixture.

That is, when unpolarized light or linearly polarized light is incident on the left-hand circular polarizer 100b, the left-hand circular polarizer 100b reflects the right-hand circularly polarized light within a predetermined wavelength range and transmits the left-hand circularly polarized light. In various examples of the circular polarizer described below, the cholesteric liquid crystal may include a dextrorotatory chiral material. In addition, the circular polarizer including the dextrorotatory chiral material may operate as the right-hand circular polarizer 100b.

The chiral material arranges nematic liquid crystals included in the cholesteric liquid crystals in a counterclockwise or clockwise helical shape. The travel distance of the nematic liquid crystal rotating 360 degrees is 1 pitch P, and the distance of rotating 180 degrees is (1/2)×P. Due to the boundary condition between the nematic liquid crystal and both substrates 110a and 110b, the nematic liquid crystal is disposed only in the direction parallel to the rubbing direction (eg, 180 degrees or 360 degrees) at the location in contact with the polyimide. Therefore, the nematic liquid crystal disposed between both substrates 110a and 110b is always an integer multiple of (1/2)×P. When the distance of one pitch is shortened, the circularly polarized PBG moves to the high-frequency band, and when the distance of one pitch is long, the circularly polarized PBG moves to the low-frequency band. The circular polarizer may reflect left-hand circularly polarized light and transmit right-hand circularly polarized light in the PBG. Alternatively, the circular polarizer may reflect right-hand circularly polarized light and transmit left-hand polarized light in the PBG.

Since frequency and wavelength are in inverse proportion to each other, circularly polarized PBG may move to the short wavelength band when the distance of the pitch is shortened, and may move to the long wavelength band when the distance of the pitch is longer. That is, when the distance of pitch of the cholesteric liquid crystal (CLC) is changed, the circularly polarized PBG may be moved.

When the length of the pitch of the cholesteric liquid crystal is continuously changed depending on the location of one circular polarizer 100, one circular polarizer 100 may circularly polarize light of various frequency bands depending on the area where light is incident.

Hereinafter, various examples of a circular polarizer will be described.

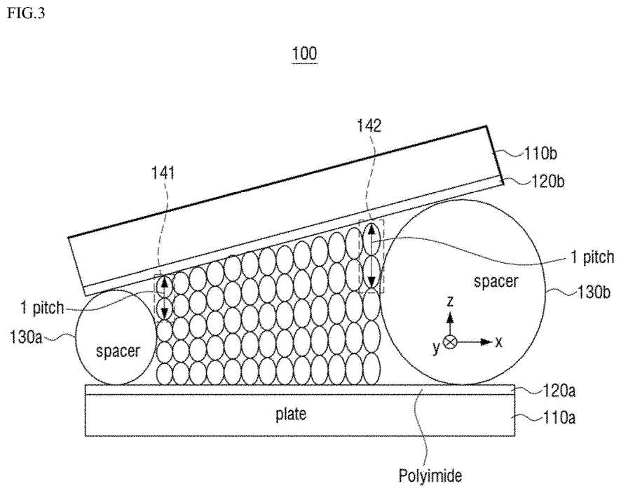

FIG. 3 illustrates an example of the cholesteric liquid crystal which is the circular polarizer 100 having a CLC structure in which the pitch is continuously increased as the location moves in the wedge direction (X-axis of FIG. 3). Such a structure may be implemented in the following examples. Depending on the location of the wedge cell, there are methods i) using a continuous change of concentration of chiral molecules, ii) using photoisomerization of azo dyes molecules and iii) using a temperature gradient.

Meanwhile, as illustrated in FIG. 3, the circular polarizer 100 may include spacers 130a and 130b having different sizes, thereby implementing a CLC structure in which the pitch is continuously increased. However, spacers 130a and 130b of different sizes may be used with the above-described three examples for a more effective CLC structure of continuously increasing pitch.

Referring to FIG. 3, a circular polarizer 100 with continuously tunable wavelength is disclosed. As described above, the circular polarizer 100 includes a pair of substrates 110a and 110b, polyimide layers 120a and 120b coated on one surface of each of the pair of the substrates, and spacers 130a and 130b. In addition, although FIG. 1 illustrates a circular polarizer 100 including spacers of the same size, the circular polarizer 100 may include spacers 130a and 130b of which the sizes are different from each other. As described above, a cholesteric liquid crystal mixed with a nematic liquid crystal and a chiral material may be included between the spacers 130a and 130b. The pitch 141 of the nematic liquid crystal around the first spacer 130a is shorter than the pitch 142 of the nematic liquid crystal around the second spacer 140b. Therefore, when the location where the light passes through the circular polarizer 100 moves along the +X-axis direction, the circularly polarized frequency band moves to the low-frequency band, and the circularly polarized wavelength band moves to the long-wavelength band.

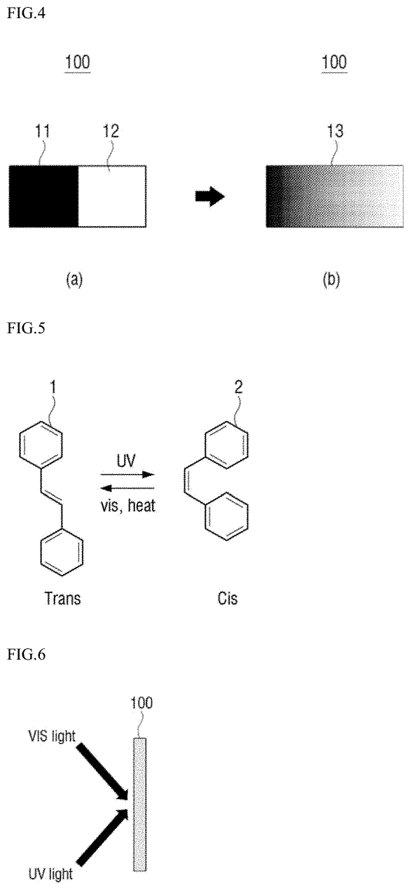

FIG. 4 illustrates a circular polarizer with a continuously tunable wavelength by using a concentration difference of a chiral material according to an example. The first method of obtaining the continuously varying pitch structure of FIG. 3 is illustrated.

FIG. 4A illustrates a cholesteric liquid crystal filled with different chiral concentrations. The cholesteric liquid crystals 11 and 12 having different chiral concentrations may be half-filled in the empty space of the spacer by the capillary principle. For example, the first cholesteric liquid crystal 11 having a relatively high chiral concentration is filled on the thinner side of the wedge empty cell, and the second cholesteric liquid crystal 12 having a lower chiral concentration is filled on the thicker side of the wedge empty cell. The chiral concentration of the discontinuous cholesteric liquid crystals 11 and 12 may form a continuous pitch change as illustrated in FIG. 3 after a predetermined time due to the diffusion principle.

FIG. 4B illustrates a cholesteric liquid crystal 13 of which the chiral concentration continuously varies by diffusion. As described above, the chiral concentration continuously decreases from the left side to the right side of FIG. 4B after a predetermined time. As described above, as the chiral concentration decreases, the length of one pitch increases, the circularly polarized frequency band moves to a low-frequency band, and the polarized circularly wavelength move to a long-wavelength band. That is, when the circular polarizer 100 includes a cholesteric liquid crystal 13 including a chiral material having a concentration gradient continuously varying in a predetermined direction, one circular polarizer 100 may circularly polarize various frequency bands of the incident light.

In addition, as described above, the circular polarizer 100 may include a cholesteric liquid crystal 13 including a chiral material having a concentration gradient continuously varying in a predetermined direction, and spacers having different sizes. The circularly polarized frequency band of the circular polarizer (100) may be continuously changed by chiral materials of the different concentration gradients and the spacers of different sizes. Further, the cholesteric liquid crystal 130 including a chiral material having a continuously varying concentration gradient can be polymerized by applying ultraviolet UV or heat. Liquid crystals that can be polymerized by ultraviolet may include RMS08-062, RMS08-061, RMS11-066 or RMS11-068, and the like. When the cholesteric liquid crystal is polymerized by ultraviolet rays or heat, the cholesteric liquid crystal having a continuously varying concentration gradient formed as illustrated in FIG. 3 may be maintained for a long time (more than a few years).

FIG. 5 illustrates azo dyes.

Referring to FIG. 5, azo dyes which are changed to trans-type or cis-type depending on the light are illustrated. For example, the azo dyes may be azobenzene. Generally, azo dyes may exist as trans-type 1. When the azo dyes are exposed to ultraviolet rays, trans-type azo dyes may be converted into a cis-type 2 in proportion to the intensity and exposure time of the ultraviolet rays by photoisomerization. Then, when the azo dyes of cis-type 2 are exposed to heat or visible light, the azo dyes of cis-type 2 may be converted into trans-type 1 by photoisomerization. The cholesteric liquid crystal may include a certain amount of azo dyes. The azo dyes may be trans-type 1. Then, the circularly polarized frequency band of the circular polarizer may be moved by the azo dyes converted into a cis-type 2.

On the other hand, the cholesteric liquid crystal may include a molecule including a stilbene group instead of azo dyes.

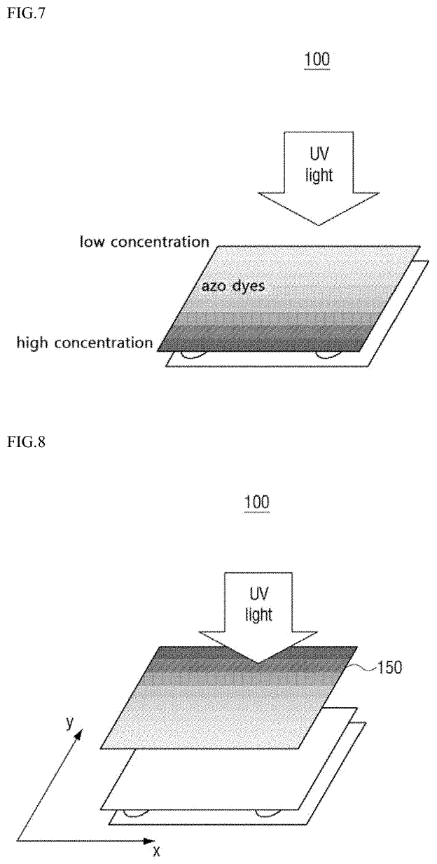

FIG. 6 illustrates a circular polarizer using azo dyes according to an example.

Referring to FIG. 6, a circular polarizer 100 including azo dyes are illustrated. The circular polarizer 100 may include a cholesteric liquid crystal in which a certain proportion of azo dyes are added. As described above, when the cholesteric liquid crystal includes a dextrorotatory chiral material, the circular polarizer 100 may be a left-hand circular polarizer. And when the cholesteric liquid crystal includes a levorotatory chiral material, the circular polarizer 100 may be a right-hand circular polarizer.

When the cholesteric liquid crystal including the azo dyes is exposed to ultraviolet rays, the azo dyes included in the cholesteric liquid crystal may be converted from trans-type to a cis-type. The cholesteric liquid crystal may include a liquid crystal capable of being polymerized by ultraviolet rays. In addition, the cholesteric liquid crystal may also include a liquid crystal that can be polymerized by heat. For example, the liquid crystal that can be polymerized by ultraviolet rays may include RMS08-062, RMS08-061, RMS11-066 or RMS11-068, and the like. When the cholesteric liquid crystal is polymerized by ultraviolet rays or heat, even if the cholesteric liquid crystal is exposed to visible light or heat, the circular polarizer 100 may be maintained as a cholesteric liquid crystal state including azo dyes converted into a cis-type.

On the other hand, the liquid crystal that is not polymerized by ultraviolet rays or heat may be a general liquid crystal. When a cholesteric liquid crystal is a general liquid crystal, the circular polarizer 100 including the azo dyes converted into a cis-type by ultraviolet rays may further include a blocking film that blocks ultraviolet rays or visible rays. Alternatively, when the cholesteric liquid crystal is a general liquid crystal, the circular polarizer 100 including the azo dyes converted into a cis-type by ultraviolet rays may return to its original state by visible light. Therefore, the circularly polarized wavelength region PBG using ultraviolet rays and visible light may be actively used.

In one example, the cholesteric liquid crystal may include 50 wt % of nematic liquid crystal, 30 wt % of chiral material, and 20 wt % of liquid crystal with azo dyes. That is, the cholesteric liquid crystal may have a proportion of 30 wt % of the chiral material to the total material. The azo dyes included in the cholesteric liquid crystal are a trans-type, and since trans-type azo dyes participate in the cholesteric helical structure together with the nematic liquid crystal, the azo dyes may affect the proportion of the chiral material. Cholesteric liquid crystals including azo dyes may be exposed to ultraviolet rays. And the azo dyes may be converted into a cis-type. However, the azo dyes converted into a cis-type by UV do not participate in the cholesteric helical structure together with the nematic liquid crystal and release from the helical structure. As a result, the proportion of chiral material to the total material configuring the cholesteric helical structure increases. When the proportion of chiral material increases the photonic band gap PBG moves to a short wavelength, and when the proportion of chiral material decreases, the PBG moves to a long wavelength.

The azo dyes converted into a cis-type do not affect the proportion of chiral materials. In other words, when all azo dyes of the azo dyes liquid crystal 20 wt % are converted into a cis-type, the azo dyes are released from the formed helical structure of the cholesteric liquid crystal. Thus, the cholesteric liquid crystal includes about 62.5 wt % of nematic liquid crystal, about 37.5 wt % of chiral material. Therefore, when the azo dyes of trans-type are converted into a cis-type, the proportion of the chiral material of the cholesteric liquid crystal is changed, and the circularly polarized frequency band PBG is moved to a short wavelength. In addition, the cholesteric liquid crystal may include azo dyes having a certain concentration corresponding to the circularly polarized frequency band.

FIG. 7 illustrates a circular polarizer using the concentration difference of the azo dyes according to an example.

Referring to FIG. 7, a circular polarizer 100 including azo dyes of a concentration gradient continuously varying in a predetermined direction is illustrated. The circular polarizer 100 may include a cholesteric liquid crystal, and the cholesteric liquid crystal may include azo dyes which are photoisomerized by ultraviolet rays.

Two different kinds of cholesteric liquid crystals having different concentrations of azo dyes may be prepared. Two different kinds of cholesteric liquid crystals having different concentrations of azo dyes may be half-filled in the empty space of the spacer by the capillary principle. For example, the first cholesteric liquid crystal may be a liquid crystal having a relatively high concentration of azo dyes, and the second cholesteric liquid crystal may be a liquid crystal having a relatively low concentration of azo dyes. The concentration of the azo dyes of the discontinuous cholesteric liquid crystal may vary continuously after a certain period of time due to the diffusion principle. As an example, after a certain period of time, the concentration of the azo dyes is continuously increased from one side to the other side as illustrated in FIG. 7.

The circular polarizer 100 of which the concentration of the azo dyes continuously varies may be exposed to ultraviolet rays. The azo dyes included in the circular polarizer 100 may be converted from a trans-type to a cis-type by ultraviolet rays. In addition, the chiral concentration included in the circular polarizer 100 may also relatively varies depending on the concentration of the azo dyes continuously varying. That is, depending on the chiral concentration continuously varying, the distance of one pitch of the nematic liquid crystal included in the circular polarizer 100 may also vary continuously. Accordingly, one circular polarizer 100 may circularly polarize light of various frequency bands of the incident light.

On the other hand, cholesteric liquid crystal including azo dyes can be polymerized by heat or ultraviolet rays. Alternatively, the circular polarizer 100 including the azo dyes may further include a film that blocks ultraviolet rays or visible light after the azo dyes are converted into a cis-type. In addition, as described above, the circular polarizer 100 may include spacers of different sizes.

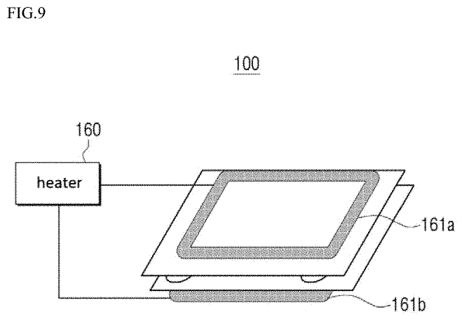

FIG. 8 illustrates manufacturing a circular polarizer capable of obtaining a continuously varying pitch structure of FIG. 3 using an ND filter 150 of which the intensity of transmitted light is continuously variable according to an example.

Referring to FIG. 8, a circular polarizer 100 including azo dyes are illustrated. The circular polarizer 100 may include a cholesteric liquid crystal in which a certain proportion of azo dyes are added. When the cholesteric liquid crystal including the azo dyes is exposed to the ultraviolet ray, the azo dyes included in the cholesteric liquid crystal may be converted from a trans-type to a cis-type. Even if the concentration of the azo dyes included in the cholesteric liquid crystal is the same, the proportion of the azo dyes that are converted into a cis-type may vary, depending on such as the intensity of ultraviolet rays or exposure time of the cholesteric liquid crystal. When the proportion of azo dyes converted to a cis-type is different, the circularly polarized frequency band of the cholesteric liquid crystal may vary.

As illustrated in FIG. 8, the circular polarizer 100 may be exposed to ultraviolet rays through a Neutral Density ND filter 150. The concentration of the ND filter 150 may vary continuously in a certain direction. That is, the amount of ultraviolet rays transmitted the ND filter 150 may vary in a predetermined direction. As an example, as illustrated in FIG. 8, the concentration of the ND filter 150 may gradually increase along the Y-axis direction. Therefore, even if uniform ultraviolet rays are emitted to the circular polarizer 100, the amount of ultraviolet rays passing through the ND filter 150 may gradually decrease along the Y-axis direction. In addition, the amount of azo dyes that are converted into a cis-type may gradually decrease. Accordingly, the circular polarizer 100 illustrated in FIG. 8 may have a pitch gradient formed in the Y-axis direction. That is, in the circular polarizer 100, the proportion of the chiral material decreases continuously along the +Y-axis direction, the pitch distance is increased, the circularly polarized frequency band moves to the low-frequency band, and the wavelength band moves to the long-wavelength band. That is, one circular polarizer 100 may circularly polarize light of various frequency bands depending on the region on which light is incident.

When the cholesteric liquid crystal is polymerized by ultraviolet rays or heat, the circular polarizer 100 may be maintained as a cholesteric liquid crystal state including azo dyes converted into a cis-type. Alternatively, the circular polarizer 100 may further include a blocking film that blocks ultraviolet rays or visible light.

Alternatively, the cholesteric liquid crystal including the azo dyes of a predetermined concentration may be exposed such that the intensity of the ultraviolet rays continuously varies in accordance with the location of the device in the predetermined direction. Therefore, the proportion of the photoisomerized azo dyes included in the circular polarizer 100 may continuously vary in a predetermined direction of the device, and may continuously vary the pitch of the cholesteric liquid crystal. In order to continuously vary the intensity of ultraviolet rays in a predetermined direction depending on the location of the device, a continuously varying ND filter may be used between the device and UV of certain intensity.

FIG. 9 illustrates a circular polarizer using heat according to an example.

FIG. 9 illustrates a circular polarizer 100 which includes a heater 160 and heater rings 161a and 161b on both substrates, respectively. The reflected frequency (or wavelength) band of the cholesteric liquid crystal may vary depending on the temperature change. The pitch of the cholesteric liquid crystal may vary in correspondence with the supplied heat. That is, the circular polarization frequency of the cholesteric liquid crystal may vary depending on the temperature change. The heater 160 can adjust the temperature of the heater rings 161a and 161b. In addition, the temperature of the heater rings 161a and 161b may vary by the heater 160. Heat supplied by the heater 160 may be transferred to the cholesteric liquid crystal through the heater rings 161a and 161b. As the temperature of the cholesteric liquid crystal varies, the reflected frequency band may move. That is, by adjusting the temperature transmitted to the cholesteric liquid crystal using the heater 160, one circular polarizer 100 may circularly polarize various frequency bands of the incident light.

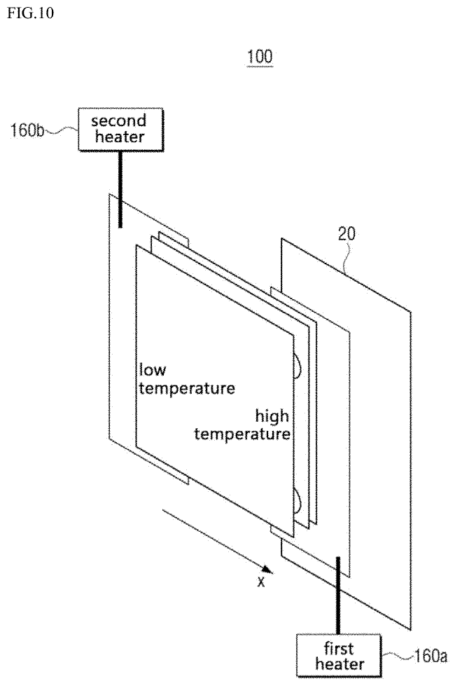

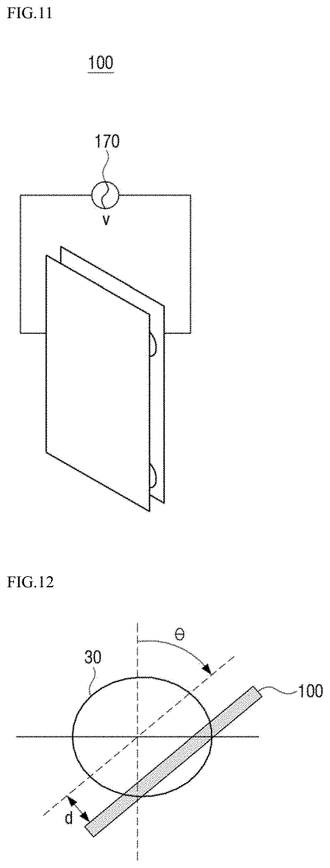

FIG. 10 illustrates a third method of manufacturing a circular polarizer capable of obtaining a continuously varying pitch structure of FIG. 3 using a temperature gradient according to an example.

Referring to FIG. 10, a circular polarizer 100 including a first heater 160a and a second heater 160b is illustrated. The first heater 160a and the second heater 160b may supply heat of different temperatures to the circular polarizer 100. For example, the first heater 160a may supply heat of a first temperature, and the second heater 160b may supply heat of a second temperature which is lower than the first temperature. The first heater 160a may be connected to one end of the substrate, and the second heater 160b may be connected to the other end of the substrate. That is, a temperature gradient may be formed in a direction from one end from the other end by the temperature difference between the first and second heaters 160a and 160b in the circular polarizer 100. As described above, the pitch of the cholesteric liquid crystal may vary with temperature. The circularly polarized frequency band may vary depending on the pitch. Therefore, the circularly polarized frequency band of the circular polarizer 100 may vary in a direction from one end where the temperature gradient is formed to the other end.

In addition, the first heater 160a and the second heater 160b may be set to various temperatures depending on the purpose. In some cases, the first heater 160a and the second heater 160b may be set to the same temperature.

The circular polarizer 100 may further include a moving stage 20 that moves in a direction parallel to the direction in which the temperature gradient is formed. The moving stage 20 may include a light source such that a location of the circular polarizer 100 on which light is incident on may vary depending on the movement of the moving stage 20. Although the moving stage 20 is described in FIG. 10, the moving stage 20 may also be included in another example in which a circularly polarized frequency band varies depending on the location one circular polarizer 100 on which light is incident.

FIG. 11 illustrates a circular polarizer with tunable wavelength using an electric field according to an example.

Referring to FIG. 11, a circular polarizer 100 connected to a power source is illustrated. For example, when the substrate is made of glass coated with ITO, the substrate may include a cell capable of receiving electricity. And, when an electric field is applied, the cholesteric liquid crystal may transmit only circularly polarized light with respect to the wavelength within the photonic band gap (reflection wavelength band of the cholesteric liquid crystal). The pitch of the cholesteric liquid crystal may vary depending on the magnitude of the supplied voltage. In addition, the circularly polarized frequency band may vary depending on the change of the pitch.

As described above, when the cholesteric liquid crystal includes a levorotatory chiral material, the circular polarizer 100 may operate as a right-hand circular polarizer. And when the cholesteric liquid crystal includes a dextrorotatory chiral material, the circular polarizer 100 may operate as a left-hand circular polarizer.

As described above, according to various examples of the circular polarizer 100, one circular polarizer 100 having a continuously varying pitch gradient depending on the location may circularly polarize the light of various frequency bands depending on the location where light is incident. Therefore, the light source or the circular polarizer 100 is to be moved so that light may be incident to various areas of the circular polarizer 100.

As one example of moving the light source, the circular polarizer 100 may include a moving stage. As described above, the moving stage may include a light source and move from one end to the other end of the circular polarizer 100. As the moving stage moves, the light source may emit light to various regions of the circular polarizer 100.

FIG. 12 illustrates a circular polarizer with tunable wavelength using a rotator according to an example.

FIG. 12 illustrates the rotator 30 in which the circular polarizer 100 is located. The rotator 30 may be used for varying the incident angle of light incident on the device, or for simultaneously varying the incident angle and the incident location of light with respect to the device. The rotator 30 may rotate with respect to the center point (or rotation axis). The circular polarizer 100 may be located at a point spaced apart from the center point of the rotator 30 by a predetermined distance. That is, when varying the location of the circular polarizer 100 so that light may be incident on various areas of the circular polarizer 100, the rotator 30 may be used instead of the moving stage. Since the circular polarizer 100 is disposed spaced apart from the center point by a predetermined distance, the axis passing the diameter of the rotator 30 may pass by various regions of the circular polarizer 100 as the rotator 30 rotates. That is, when the light source is disposed on the same axis as the diameter of the rotator 30, the light source may emit light to various areas of the circular polarizer 100 as the rotator 30 rotates. Accordingly, the rotator 30 may be applied to various examples of one circular polarizer 100 having a pitch gradient formed thereon.

Various examples of the circular polarizer 100 have been described. Hereinafter, various filters including the circular polarizer 100 will be described.

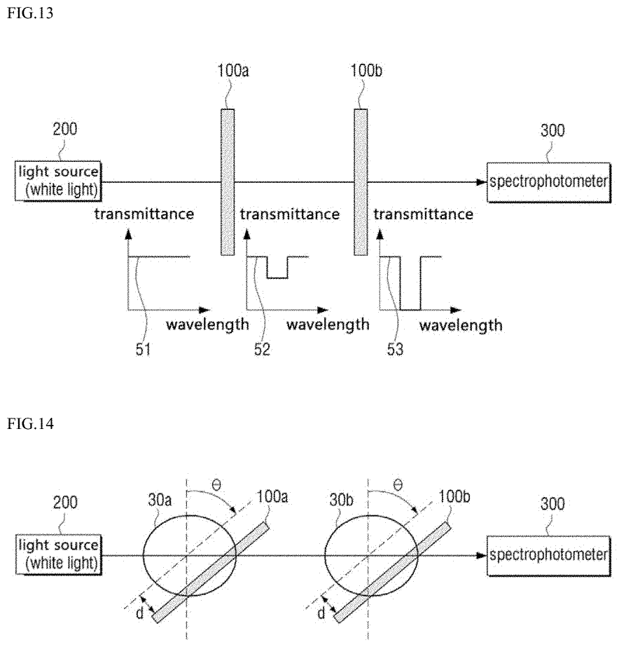

FIGS. 13 to 19 illustrate a notch filter according to various examples.

Referring to FIG. 13, a notch filter of the first example including the circular polarizer 100 is illustrated.

The notch filter includes a right-hand circular polarizer 100a and a left-hand circular polarizer 100b. The output waveform of the notch filter may be detected using a spectrophotometer. That is, a notch filter for blocking the transmission of light in the predetermined frequency band PBG may be implemented by combining one right-hand circular polarizer 100a and one left-hand circular polarizer 100b of a predetermined concentration.

As described above, the right-hand circular polarizer 100a includes a levorotatory chiral material in the cholesteric liquid crystal. Accordingly, the right-hand circular polarizer 100a has a characteristic of reflecting left-hand circularly polarized light of a certain wavelength (or frequency) band and transmitting right-hand circularly polarized light. The left-hand circular polarizer 100b includes a dextrorotatory chiral material in the cholesteric liquid crystal. Therefore, the left-hand circular polarizer 100b has a characteristic of reflecting right-hand circularly polarized light of a predetermined frequency band and transmitting left-hand circularly polarized light.

Referring to FIG. 13, light 51 is output from the light source 200. The light 51 output from the light source 200 may be unpolarized light (non-polarized light) or linearly polarized light. Unpolarized light and linearly polarized light are composed of 50% of right-hand circular polarization and 50% of left-hand circular polarization, respectively.

The right-hand circular polarizer 100a reflects left-hand circularly polarized light of a specific wavelength PBG and transmits right-hand circularly polarized light. Therefore, the light 52 passed through the right-hand circular polarizer 100a may have a waveform in which the left-hand circularly polarized light component is removed from the PBG. Light passed through the right-hand circular polarizer 100a reaches the left-hand circular polarizer 100b.

The left-hand circular polarizer 100b reflects the right-hand circularly polarized light of PBG. Accordingly, the light 53 passed through the left-hand circular polarizer 100b may have a waveform in which the right-hand circularly polarized light component is removed at a specific wavelength. As described above, since the left-hand circularly polarized light component in the PBG is removed at the right-hand circular polarizer 100a and the right-hand circularly polarized light component is removed from the left-hand circular polarizer 100b, accordingly, the light 53 passed through the two polarizers may have a waveform in which all wavelengths in the PBG removed. Therefore, the notch filter may be implemented using the right-hand circular polarizer 100a and the left-hand circular polarizer 100b. In addition, the notch filter may be implemented by varying the disposed locations of the right-hand circular polarizer 100a and the left-hand circular polarizer 100b. That is, the left-hand circular polarizer 100b is disposed first such that the light output from the light source 200 passes through left-hand circular polarizer 100b and then passes through the right-hand circular polarizer 100a. Various examples of the arrangement order of the right-hand circular polarizer 100a and the left-hand circular polarizer 100b may be applied to various notch filters described below.

A notch filter may be implemented using the right-hand circular polarizer 100a and the left-hand circular polarizer 100b of the above-described various examples.

FIG. 14 illustrates a notch filter of the second example.

Referring to FIG. 14, a notch filter implemented with a right-hand circular polarizer 100a including a first rotator 30a and a left-hand circular polarizer 100b including a second rotator 30b is illustrated. As each of the first rotator 30a and the second rotator 30b rotate respectively, the PBG locations of the right-hand and left-hand circular polarizers 100a and 100b may move to short wavelength, respectively, and locations of changed PBG of the two circular polarizers are adjusted by varying rotation angle, thereby, a notch filter with tunable wavelength may be implemented. The right-hand and left-hand circular polarizers 100a and 100b each have a certain concentration of chiral molecules, and the movement of the location of the PBG by rotation is unrelated to the rotation direction, therefore, may be turned clockwise or counterclockwise.

In addition, in FIG. 14, the right-hand circular polarizer 100a and the left-hand circular polarizer 100b may be circular polarizers each having a pitch gradient according to various methods. For example, the right-hand circular polarizer 100a and the left-hand circular polarizer 100b may include different spacers, may be devices in which a gradient of a chiral material concentration is formed, or maybe a gradient using photoisomerization of azo dyes, or may form a pitch gradient using a temperature gradient. The right-hand circular polarizer 100a and the left-hand circular polarizer 100b may be devices in which only the properties of the chiral material are different and gradients of the same manner and of similar concentration are formed.

The right-hand circular polarizer 100a and the left-hand circular polarizer 100b may be disposed in a region spaced apart by a predetermined distance from the rotation axes of the first and second rotators 30a and 30b, respectively. The first and second rotators 30a and 30b may rotate at the same angle. In some cases, the first rotator 30a and the second rotator 30b may rotate at different angles. As an example, the first and second rotators 30a and 30b may rotate from 0 degree to 90 degrees. The light source 200 may be disposed on the same axis as the diameters of the first and second rotators 30a and 30b. Therefore, the light output from the light source 200 may emit to the corresponding region to the right-hand circular polarizer 100a and the left-hand circular polarizer 100b. Light passed through the left-hand circular polarizer 100a and the right-hand circular polarizer 100b may be detected by the spectrometer 300.

The light output from the light source 200 may be emitted to various regions of the right-hand circular polarizer 100a and the left-hand circular polarizer 100b depending on the rotation of the first and second rotators 30a and 30b. The right-hand circular polarizer 100a and the left-hand circular polarizer 100b may reflect light of different wavelength (or frequency) bands depending on the region where light is emitted by a gradient of the pitch. Therefore, the notch filter illustrated in FIG. 14 may remove light of various wavelength bands as the first and second rotators 30a and 30b rotate.

Examples of the rotator may be applied to various notch filters.

FIG. 15 illustrates a notch filter of the third example.

Referring to FIG. 15, the notch filter may include a right-hand circular polarizer 100a and a left-hand circular polarizer 100b in which a gradient of chiral concentration is formed. In addition, the right-hand circular polarizer 100a and the left-hand circular polarizer 100b may include the first moving stage 20a and the second moving stage 20b, respectively. The first and second moving stages 20a and 20b may move the right-hand circular polarizer 100a and the left-hand circular polarizer 100b, each of which has a gradient formed thereon. The first and second moving stages 20a and 20b may move the same distance. In some cases, the first and second moving stages 20a and 20b may move different distances.

As the first and second moving stages 20a and 20b move, the light output from the light source 200 may be emitted to various regions of the right-hand circular polarizer 100a and the left-hand circular polarizer 100b. As the light output from the light source 200 is emitted to various regions of the right-hand circular polarizer 100a and the left-hand circular polarizer where the gradient is formed, the notch filter may remove light of various wavelength bands. Examples of the moving stage may be applied to various notch filters.

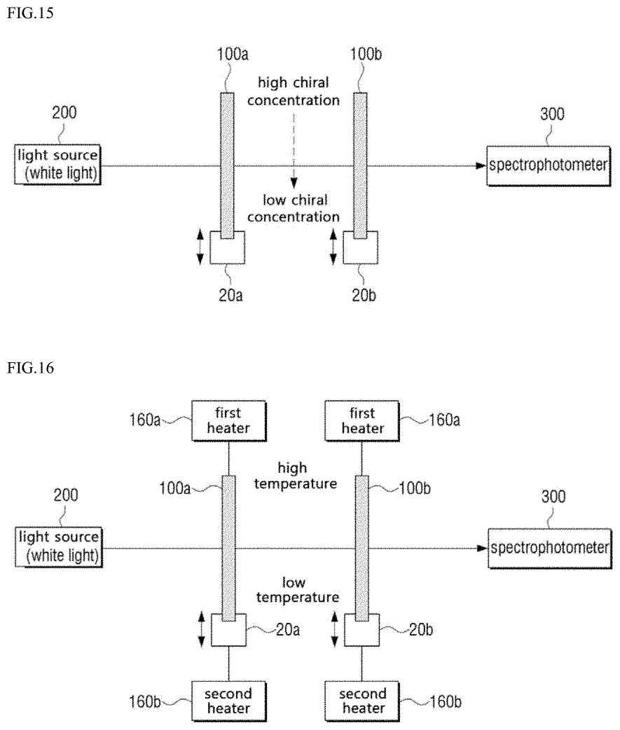

FIG. 16 illustrates a notch filter of the fourth example.

Referring to FIG. 16, the notch filter may include a first heater 160a and a second heater 160b in the right-hand circular polarizer 100a and the left-hand circular polarizer 100b of a predetermined concentration. Alternatively, the notch filter may include a first moving stage 20a and a second moving stage 20b in the right-hand circular polarizer 100a and the left-hand circular polarizer 100b of a predetermined concentration.

The light source 200 outputs light. The first heater 160a may supply heat of a first temperature to one ends of the right-hand circular polarizer 100a and the left-hand circular polarizer 100b. The second heater 160b may supply heat of a second temperature different from the first temperature to the other ends of the right-hand circular polarizer 100a and the left-hand circular polarizer 100b. As described above, a temperature gradient may be formed in the right-hand circular polarizer 100a and the left-hand circular polarizer 100b, by the heat of different temperatures supplied from the first heater 160a and the second heater 160b, respectively. In addition, the right-hand circular polarizer 100a and the left-hand circular polarizer 100b may reflect light components of various wavelength depending on the region to which light is emitted.

The notch filter illustrated in FIG. 16 may adjust the wavelength band of reflected light by adjusting the temperature of heat supplied from the first heater 160a and the second heater 160b. Alternatively, the notch filter illustrated in FIG. 16 may include a first moving stage 20a and a second moving stage 20b. Each of the first moving stage 20a and the second moving stage 20b may adjust the wavelength band of the reflected light by moving the right-hand circular polarizer 100a and the left-hand circular polarizer 100b by the same distance. Alternatively, the first moving stage 20a and the second moving stage 20b may individually control the right-hand circular polarizer 100a and the left-hand circular polarizer 100b to adjust the wavelength band of the reflected light.

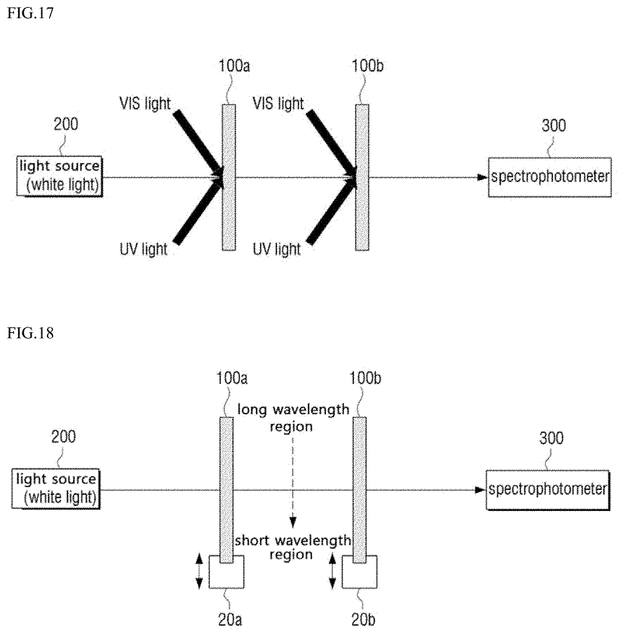

FIG. 17 illustrates a notch filter of the fifth example.

Referring to FIG. 17, the notch filter may include a right-hand circular polarizer 100a and a left-hand circular polarizer 100b including a certain amount of azo dyes. As described above, when ultraviolet rays are emitted to the right-hand circular polarizer 100a and the left-hand circular polarizer 100b including the azo dyes, the PBG of each circular polarizer may be moved toward the short wavelength, and the moved PBG location may move back to long wavelength when emitted by the visible light VIS. The concentration of azo dyes included in the right-hand circular polarizer 100a and the left-hand circular polarizer 100b may be variously set depending on the purpose of the notch filter.

The characteristics of the linear polarizer including the azo dyes and the characteristics of the notch filter including the right-hand circular polarizer 100a and the left-hand circular polarizer 100b are the same as the above-described examples, and thus, detailed description thereof will be omitted.

The cholesteric liquid crystals of the right-hand circular polarizer 100a and the left-hand circular polarizer 100b may be polymerized by heat or ultraviolet rays. Alternatively, the right-hand circular polarizer 100a and the left-hand circular polarizer 100b may further include a blocking film capable of blocking ultraviolet rays or visible light.

FIG. 18 illustrates a notch filter of the sixth example.

Referring to FIG. 18, a notch filter including a right-hand circular polarizer 100a and a left-hand circular polarizer 100b in which a gradient is formed depending on the concentration of azo dyes converted into a cis-type is illustrated.

As an example, the right-hand circular polarizer 100a and the left-hand circular polarizer 100b may each include azo dyes of a uniform concentration and an ND filter of certain concentration. The amount or intensity of ultraviolet rays emitted on the respective regions of the right-hand circular polarizer 100a and the left-hand circular polarizer 100b by the ND filter may vary. The proportion of azo dyes converted into a cis-type in each region may vary depending on the amount or intensity of ultraviolet rays. The wavelength of light reflected from each region of the right-hand circular polarizer 100a and the left-hand circular polarizer 100b may vary depending on the proportion of the azo dyes.

Since the characteristics of the linear polarizer including the azo dyes and the notch filter including the right-hand circular polarizer 100a and the left-hand circular polarizer 100b are the same as the above-described examples, detailed descriptions thereof will be omitted.

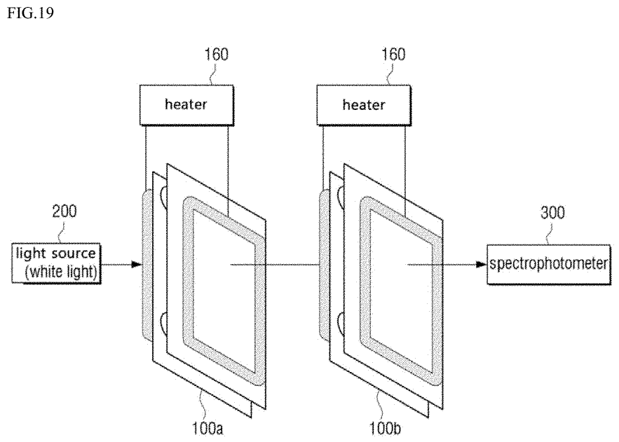

FIG. 19 illustrates a notch filter of the seventh example.

Referring to FIG. 19, the notch filter may include a heater 160. The heater 160 may supply heat to each surface of the right-hand circular polarizer 100a and the left-hand circular polarizer 100b. As the temperature of the heater 160 is controlled, the wavelength of the light reflected from the right-hand circular polarizer 100a and the left-hand circular polarizer 100b may vary.

On the other hand, the notch filter may be implemented as one device.

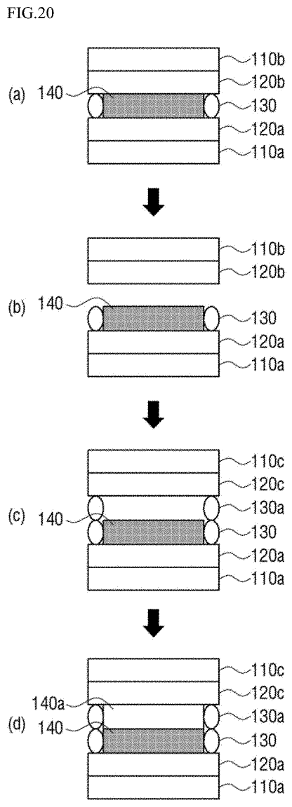

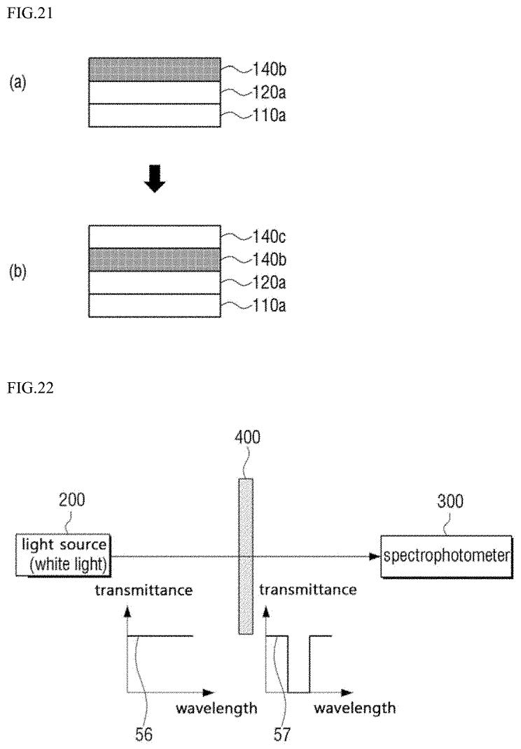

FIGS. 20 and 21 illustrate a method of implementing a notch filter according to another example.

Referring to FIG. 20(a), the above-described circular polarizer is illustrated. That is, polyimide layers 120a and 120b are coated on one surface of each of the pair of the substrates 110a and 110b. The rubbing process may be performed to the polyimide layers 120a and 120b in some cases. Next, a cell is manufactured using spacer 130 between the polyimide layers 120a and 120b, and a mixture of nematic liquid crystal and chiral material (dopant) is injected. In one example, the chiral material may be a levorotatory chiral material. When the levorotatory chiral material is injected into the cell, the nematic liquid crystals are disposed in counterclockwise helical. After the injection of chiral material, the ultraviolet rays are emitted to polymerize the cholesteric liquid crystal layer 140. One substrate 110b coated with the polyimide layer 120b of the polymerized circular polarizer is removed. FIG. 20(b) illustrates one substrate 110b coated with the polyimide layer 120b of the circular polarizer is removed. After one substrate 110b of the circular polarizer is removed, a cell is manufactured using the spacer 130a.

FIG. 20(c) illustrates a device including a new cell. The cell is manufactured using the substrate 110c coated with the polyimide layer 120c and a new spacer 130a. Then, a nematic liquid crystal and a chiral material are injected into the manufactured cell.

FIG. 20(d) illustrates a device of a two-layer structure each having left-hand and right-hand circular polarization characteristics, including a new cholesteric liquid crystal layer 140a in which a nematic liquid crystal and a chiral material are injected into the manufactured cell. As described above, when the cholesteric liquid crystal layer 140 of FIG. 20(a) includes a levorotatory chiral material, the new cholesteric liquid crystal layer 140a includes a dextrorotatory chiral material. Meanwhile, when the cholesteric liquid crystal layer 140 of FIG. 20(a) includes a dextrorotatory chiral material, the new cholesteric liquid crystal layer 140a includes a levorotatory chiral material. When a levorotatory chiral material is included, the light passed through the cholesteric liquid crystal layer has right-hand circular polarization characteristics, and when a dextrorotatory chiral material is included, the light passed through the cholesteric liquid crystal layer has left-hand circular polarization characteristics. That is, the manufacturing order of the cholesteric liquid crystal layer of the left-hand circular polarization characteristics and the cholesteric liquid crystal layer of right-hand circular polarization characteristics may be changed. In addition, the concentration of chiral molecules injected into the existing cholesteric liquid crystal layer 140 and the new cholesteric liquid crystal layer 140a to match the location of the PBG may be adjusted.

In some cases, in the pair of the substrates 110a and 110c, the surface where the polyimide is not coated for incident light may be used as anti-reflective coated on the surface. In addition, the cholesteric liquid crystal layers 140 and 140a used to manufacture the notch filter may be a material that can be polymerized by ultraviolet rays or heat.

In addition, the notch filter may be manufactured in other ways.

Referring to FIG. 21A, after the polyimide layer 120a is coated, the cholesteric liquid crystal layer 140b is spin-coated on the rubbed polyimide layer 120a. For example, the cholesteric liquid crystal layer 140b may include a dextrorotatory chiral material, and the cholesteric liquid crystal layer 140b has left-hand circular polarization characteristics. Since the cholesteric liquid crystal layer 140b is manufactured through the spin-coating process, only one substrate 110a is used. Next, the heat treatment process is performed at about 100 degrees for about 1 minute, and the cholesteric liquid crystal layer 140b is cooled at room temperature slowly such that a cholesteric helical structure is formed better and thereafter ultraviolet rays are emitted to form the cholesteric liquid crystal layer 140b is polymerized. The new cholesteric liquid crystal layer 140c is spin-coated on the spin-coated cholesteric liquid crystal layer 140b and formed in the same manner as the existing cholesteric liquid crystal layer 140b.

FIG. 21B illustrates a device in which a new cholesteric liquid crystal layer 140c is formed. When the previous cholesteric liquid crystal layer 140b includes a dextrorotatory chiral material, the new cholesteric liquid crystal layer 140c includes a levorotatory chiral material. The spin-coating process is performed to form two layers of cholesteric liquid crystal layers 140b and 140c in the device. The heat treatment process is performed at about 100 degrees for about 1 minute so that the new cholesteric liquid crystal layer 140c is formed better, and when the ultraviolet rays are emitted, the new cholesteric liquid crystal layer 140c is polymerized. The concentration of chiral molecules injected into the existing cholesteric liquid crystal layer 140b and the new cholesteric liquid crystal layer 140c to match the location of the PBG may be adjusted. In addition, the cholesteric liquid crystal layers 140b and 140c used in the manufacture of the notch filter may be a material which can be polymerized by ultraviolet rays or heat.

FIG. 22 illustrates a notch filter of the eighth example.

Referring to FIG. 22, a notch filter 400 formed as one device is illustrated. As described above, the notch filter 400 includes a double layer of a right-hand circularly polarized cholesteric liquid crystal and a left-hand circularly polarized cholesteric liquid crystal. Light 56 is output from the light source 200. The light 56 output from the light source 200 may be unpolarized light or linearly polarized light. The unpolarized light and the linearly polarized light are composed of 50% of right-hand circularly polarized light and 50% of left-hand circularly polarized light, respectively. The light 56 output from the light source 200 passes through the right-hand circularly polarized cholesteric liquid crystal and the left-hand circularly polarized cholesteric liquid crystal of the notch filter. The right-hand circularly polarized cholesteric liquid crystal of the notch filter 400 reflects the left-hand circularly polarized light component in the PBG. The left-hand circularly polarized cholesteric liquid crystal of the notch filter 400 reflects the right-hand circularly polarized light component in the PBG. The PBG of the right-hand circularly polarized cholesteric liquid crystal and the left-hand circularly polarized cholesteric liquid crystal of the notch filter 400 are substantially identical to each other. Therefore, the light 57 passed through the notch filter 400 may have a waveform in which all components of the PBG region are removed.

The waveform of the light 57 passed through the notch filter 400 may be detected using a spectrophotometer.

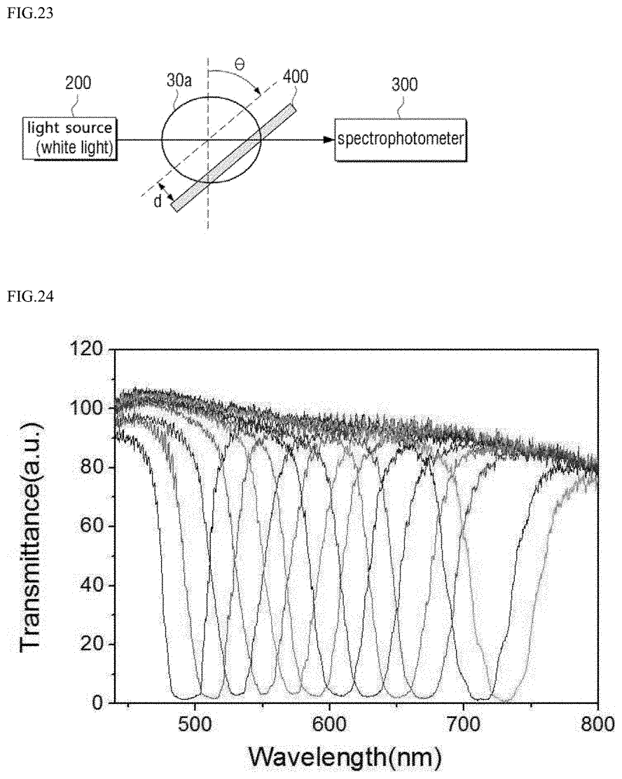

FIG. 23 illustrates a notch filter of the ninth example.

Referring to FIG. 23, a notch filter 400 disposed in a rotator 30a is illustrated. The notch filter 400 includes a right-hand circularly polarized cholesteric liquid crystal and a left-hand circularly polarized cholesteric liquid crystal. Light 56 is output from the light source 200. As the rotator 30a rotates, the location of PBG of the notch filter 400 may move to a short wavelength.

At this time, the right-hand circularly polarized cholesteric liquid crystal and the left-hand circularly polarized cholesteric liquid crystal in the notch filter 400 each have a certain amount of the concentration of chiral molecules, and movement of the location of the PBG by rotation is unrelated to the rotation direction, therefore, may be turned clockwise or counterclockwise

In addition, in FIG. 23, the right-hand circularly polarized cholesteric liquid crystal and the left-hand circularly polarized cholesteric liquid crystal in the notch filter 400 may each have a pitch gradient according to various methods. For example, the right-hand circularly polarized cholesteric liquid crystal and the left-hand circularly polarized cholesteric liquid crystal may be a device in which a gradient of a chiral material concentration is formed, or a device in which a gradient is formed using photoisomerization of azo dyes, or a pitch gradient is formed using a temperature gradient. The right-hand circularly polarized cholesteric liquid crystal and the left-hand circularly polarized cholesteric liquid crystal may have gradients of the same manner and similar concentration but only the properties of the chiral material are different.

The notch filter 400 may be disposed spaced apart from the rotation axis of the rotator 30a by a predetermined distance. In one example, the rotator 30a may rotate from −90 degrees to near 90 degrees. The light source 200 may be disposed on the same axis as the diameter of the rotator 30a. Light passed through the notch filter 400 may be detected by the spectrometer 300.

Light output from the light source 200 may be emitted to various regions of the notch filter 400 depending on the rotation of the rotator 30a. The notch filter 400 may reflect light of a different wavelength (or frequency) band depending on the region where light is emitted by a gradient of a pitch. Accordingly, the notch filter 400 illustrated in FIG. 23 may remove light of various wavelength bands as the rotator 30a rotates.

FIG. 24 illustrates an output waveform of a notch filter according to an example.

FIG. 24 illustrates a waveform of a notch filter according to various examples. As illustrated in FIG. 24, one notch filter may remove various wavelength of light depending on various gradients formed in the right-hand circular polarizer and the left-hand circular polarizer. For example, the waveform of the notch filter illustrated in FIG. 24 shows that light of continuous and various wavelengths from a wavelength of about 500 nm to about 730 nm may be removed.

Various examples of the notch filter using the linear polarizer have been described. As described above, the example of the notch filter is not limited to the example illustrated in the drawings. If a specific wavelength (or frequency) band can be removed using the various linear polarizers described above, the notch filter may be implemented by combining various linear polarizers.

Hereinafter, various examples of the bandpass filter using the linear polarizer will be described.

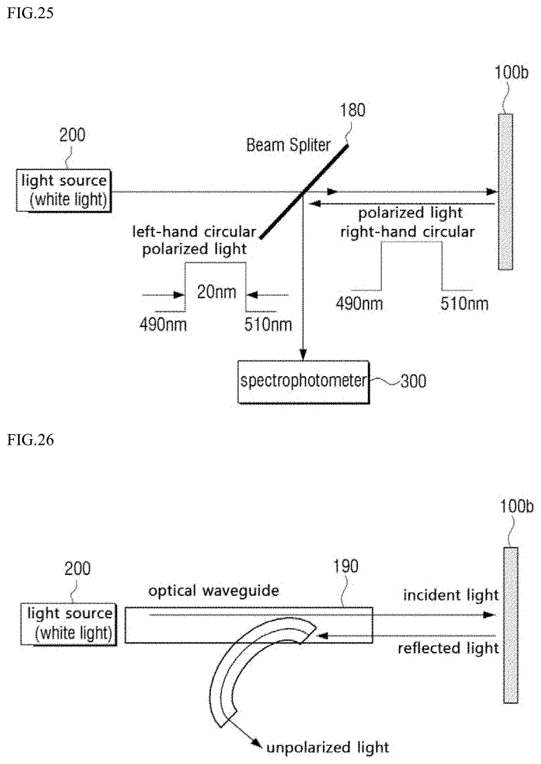

FIGS. 25 to 38 illustrate a bandpass filter according to various examples.

FIG. 25 illustrates a bandpass filter of the first example.

Referring to FIG. 25, the bandpass filter may include a beam splitter 180 and a left-hand circular polarizer 100b. The light source 200 outputs light. The output light may be unpolarized light or linearly polarized light. Light output from the light source 200 may pass through the beam splitter 180. Light passed through the beam splitter 180 reaches the left-hand circular polarizer 100b. The left-hand circular polarizer 100b may reflect the right-hand circularly polarized light of a specific wavelength band among the reached lights. For example, the specific wavelength band may be between 490 nm and 510 nm. Right-hand circularly polarized light reflected by the left-hand circular polarizer 100b may be reflected by the beam splitter 180. Right-hand circularly polarized light reflected by the beam splitter 180 is converted into left-hand circularly polarized light. That is, the spectrometer 300 can only detect left-hand circularly polarized light of the wavelength band between 490 nm and 510 nm by the beam splitter 180 and the left-hand circular polarizer 100b among the light output from the light source 200. That is, the filter illustrated in FIG. 25 is a bandpass filter which only passes light of the wavelength between 490 nm and 510 nm.

Although the left-hand circular polarizer 100b is used in FIG. 25, a bandpass filter may also be implemented using the right-hand circular polarizer 100a. When the bandpass filter includes the right-hand circular polarizer 100a, the light output from the light source 200 passes through the beam splitter 180 to reach the right-hand circular polarizer 100a. The right-hand circular polarizer 100a may reflect left-hand circularly polarized light of a specific wavelength band. For example, the specific wavelength band may be between 490 nm and 510 nm. The left-hand circularly polarized light reflected by the right-hand circular polarizer 100a may be reflected by the beam splitter 180. The left-hand circularly polarized light reflected by the beam splitter 180 is converted into right-hand circularly polarized light. That is, the spectrometer 300 may detect only right-hand circularly polarized light of a wavelength band of 490 nm to 510 nm by the beam splitter 180 and the right-hand circular polarizer 100a among the light output from the light source 200. That is, the filter is a bandpass filter which only transmits light of wavelength band between 490 nm and 510 nm.

Meanwhile, an optical waveguide may be disposed instead of the beam splitter. That is, a bandpass filter may be implemented to pass light of a specific wavelength band by reflecting or separating light reflected from the right-hand circular (or left-hand circular) polarizer 100a to a beam splitter or an optical waveguide.

FIG. 26 illustrates a bandpass filter of the second example.

Referring to FIG. 26, the bandpass filter may include an optical waveguide 190. Light output from the light source 200 may pass through the optical waveguide 190 to reach the left-hand circular polarizer 100b. The left-hand circular polarizer 100b may reflect the right-hand circularly polarized light of the reached light. The reflected right-hand circularly polarized light may be totally reflected countless times in the waveguide through a branch of the optical waveguide 190 and output in unpolarized light state. The spectrometer may be located at the end of the branch. The spectrometer may detect light of a specific wavelength band output from the optical waveguide.

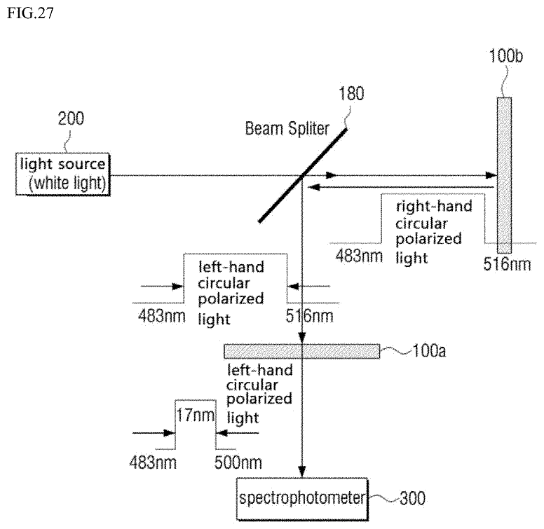

FIG. 27 illustrates a bandpass filter of the third example.

Referring to FIG. 27, the bandpass filter may include a left-hand circular polarizer 100b and a right-hand circular polarizer 100a. Light output from the light source 200 passes through the beam splitter 180 to reach the left-hand circular polarizer 100b. Among the light reaching the left-hand circular polarizer 100b, the right-hand circularly polarized light of a specific wavelength is reflected by the left-hand circular polarizer 100b. For example, the specific wavelength may be between 483 nm and 516 nm. The reflected right-hand circularly polarized light is reflected by the beam splitter 180 and is converted into left-hand circularly polarized light. The light converted into the left-hand circularly polarized light reaches the right-hand circular polarizer 100a.

On the other hand, the polarized wavelength band of the left-hand circular polarizer 100b may be different from the polarized wavelength band of the right-hand circular polarizer 100a. For example, the polarized wavelength of the left-hand circular polarizer 100b may be between 483 nm and 516 nm, and the polarized wavelength of the right-hand circular polarizer 100a may be between 500 nm and 534 nm.

That is, the wavelength band of the light reaching the right-hand circular polarizer 100a is left-hand circularly polarized light of between 483 nm and 516 nm. The right-hand circular polarizer 100a reflects left-hand circularly polarized light of between 500 nm and 534 nm. Therefore, the light passed through the right-hand circular polarizer 100a is left-hand circularly polarized light of between 483 nm and 500 nm. Light passed through the right-hand circular polarizer 100a may be detected by the spectrometer 300.

As described above, the location of the left-hand circular polarizer 100b and the location of the right-hand circular polarizer 100a may vary. A bandpass filter capable of adjusting the transmitting band gap using the left-hand circular polarizer 100b and the right-hand circular polarizer 100a of different reflected wavelength bands may be implemented.

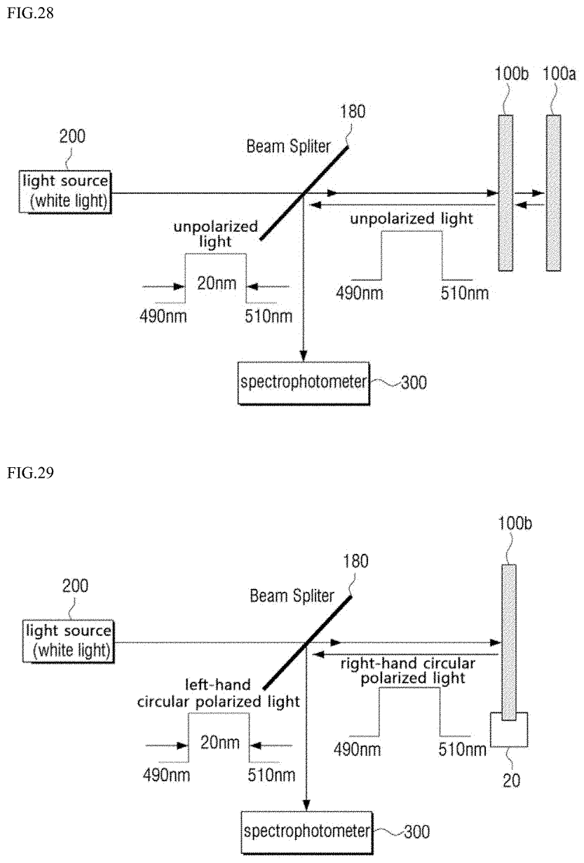

FIG. 28 illustrates a bandpass filter of the fourth example.

Referring to FIG. 28, the bandpass filter may include a beam splitter 180, a left-hand circular polarizer 100b, and a right-hand circular polarizer 100a. In FIG. 28, the wavelength bands reflected by the left-hand circular polarizer 100b and the right-hand circular polarizer 100a may be identical to each other. For example, as illustrated in FIG. 28, the reflected wavelength band is assumed to be between 490 nm and 510 nm.

The light output from the light source 200 and passed through the beam splitter 180 reaches the left-hand circular polarizer 100b. Right-hand circularly polarized light of between 490 nm and 510 nm is reflected, and the rest of the light including left-hand circularly polarized light of between 490 nm and 510 nm passes through. Then, the left-hand circularly polarized light of 490 nm to 510 nm is reflected by the right-hand circular polarizer 100a. The reflected left-hand circularly polarized light passes through the left-hand circular polarizer 100b. Therefore, the light directed from the left-hand circular polarizer 100b to the beam splitter 180 may include both left-hand circularly polarized component and right-hand circularly polarized component. That is, the light directed from the left-hand circular polarizer 100b to the beam splitter 180 may be unpolarized light. The unpolarized light may be reflected at the beam splitter 180.

The bandpass filter in which the left-hand circular polarizer 100b and the right-hand circular polarizer 100a are disposed sequentially may pass light of a specific wavelength band including both the left-hand circularly polarized component and the right-hand circularly polarized component.

FIG. 29 illustrates a bandpass filter of the fifth example.

Referring to FIG. 29, the bandpass filter may include a left-hand circular polarizer 100b disposed on the moving stage 20. The basic operation of the bandpass filter is the same as described above. In the left-hand circular polarizer 100b of FIG. 29, pitch gradients are formed depending on locations. Therefore, in the left-hand circular polarizer 100b, the reflected wavelength band may vary depending on the region in which the light output from the light source 200 reaches the device. Therefore, the wavelength band passed through may also vary as the area of the left-hand circular polarizer 100b varies in which the light is reached by the moving stage 20. Since the linear polarizer in which a gradient is formed is described above, a detailed description thereof will be omitted.

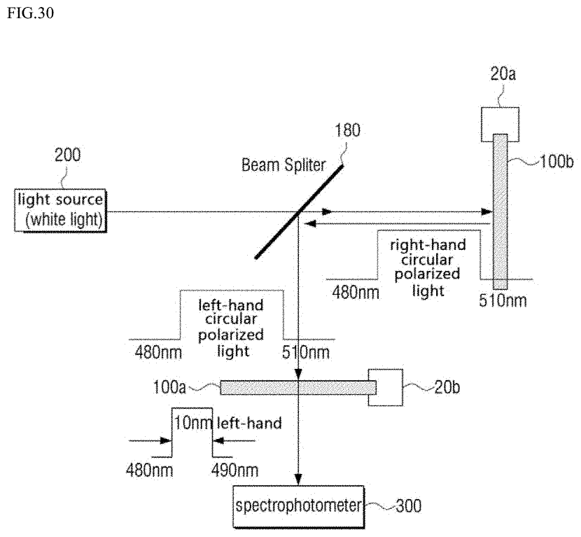

FIG. 30 illustrates a bandpass filter of the sixth example.

Referring to FIG. 30, the bandpass filter may include a left-hand circular polarizer 100b and a right-hand circular polarizer 100a each connected to a beam splitter 180 and moving stages 20a and 20b, respectively. As described above, the left-hand circular polarizer 100b and the right-hand circular polarizer 100a may reflect the light of various wavelength bands depending on the location where the light reaches, since the left-hand circular polarizer 100b and the right-hand circular polarizer 100a have pitch gradients formed therein. In addition, the moving stage 20 may adjust an area of the polarizer to which light reaches.

Some components of the light output from the light source 200 passes through the beam splitter 180 are reflected by the left-hand circular polarizer 100b. Some components of the reflected light are of a specific wavelength band and have right-hand circular polarization characteristics. Then, the reflected right-hand circularly polarized light is changed to the left-hand circularly polarized light by the beam splitter. Some components of the changed left-hand circularly polarized light are reflected by the right-hand circular polarizer 100a. Therefore, only light of a specific wavelength band by the combination of the left-hand circular polarizer 100b and the right-hand circular polarizer 100a may be passed and detected by the spectrometer 300.

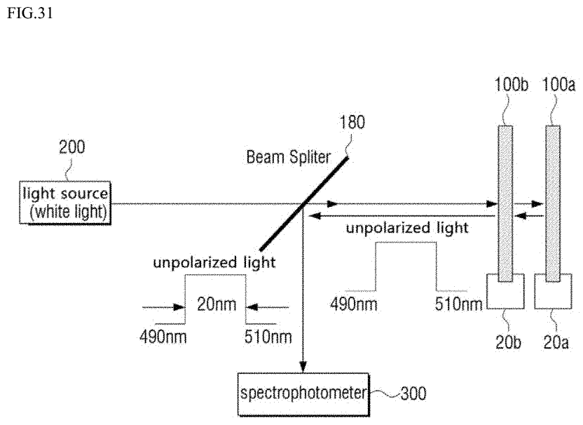

FIG. 31 illustrates a bandpass filter of the seventh example.

Referring to FIG. 31, the bandpass filter may include a beam splitter 180, a left-hand circular polarizer 100b, and a right-hand circular polarizer 100a. As described above, when the left-hand circular polarizer 100b and the right-hand circular polarizer 100a are disposed sequentially, the spectrometer 300 may detect unpolarized light of a specific wavelength band.

When pitch gradients are formed on the left-hand circular polarizer 100b and the right-hand circular polarizer 100a, locations at which light is reached by the moving stages 20a and 20b of the left-hand circular polarizer 100b and the right-hand circular polarizer 100a may be adjusted. In addition, various band gaps (pass bands) may be set by the combination of the left-hand circular polarizer 100b and the right-hand circular polarizer 100a. As described above, the bandpass filter may be implemented as an optical waveguide instead of the beam splitter 180.

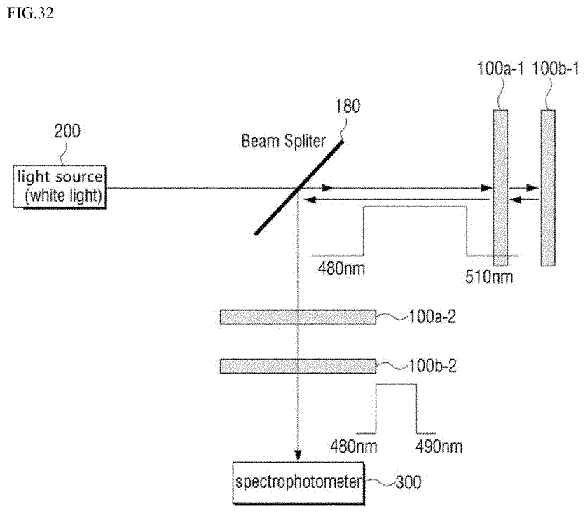

FIG. 32 illustrates a bandpass filter of the eighth example.

Referring to FIG. 32, the bandpass filter may include two left-hand circular polarizers 100b-1 and 100b-2 and two right-hand circular polarizers 100a-1 and 100a-2. The first right-hand circular polarizer 100a-1 and the first left-hand circular polarizer 100b-1 located in a region where the light output from the light source 200 and passes through the beam splitter 180 is reached may reflect left-hand circularly polarized light and right-hand circularly polarized light of a specific wavelength band, respectively. Therefore, the light reflected from the first right-hand circular polarizer 100a-1 and the first left-hand circular polarizer 100b-1 and directed toward the beam splitter 180 may be unpolarized light.

Then, the second right-hand circular polarizer 100a-2 and the second left-hand circular polarizer 100b-2 located in the region where the light reflected by the beam splitter 180 reaches may adjust a band gap (passing wavelength band). For example, the circularly polarized wavelength band of the first right-hand circular polarizer 100a-1 and the first left-hand circular polarizer 100b-1 is between 480 nm and 510 nm, and the circularly polarized wavelength band of the second right-hand circular polarizer 100a-2 and second left-hand circular polarizer 100b-2 may be between 490 nm and 520 nm.

The light reflected from the first right-hand circular polarizer 100a-1 and the first left-hand circular polarizer 100b-1 is unpolarized light of between 480 nm and 510 nm. And, when the reflected unpolarized light reaches the second right-hand circular polarizer 100a-2, only the left-hand circularly polarized light of between 490 nm and 520 nm is reflected. Accordingly, the unpolarized light having a wavelength range of 480 nm to 490 nm and the right-hand circularly polarized light having a wavelength range of 490 nm to 510 nm may pass through the second right-hand circular polarizer 100a-2. The second left-hand circular polarizer 100b-2 reflects only right-hand circularly polarized light of between 490 nm and 520 nm. Therefore, the unpolarized light having a wavelength range of 480 nm to 490 nm may pass through the second left-hand circular polarizer 100b-2 and be detected by the spectrometer 300.

As described above, the bandpass filter may include an optical waveguide instead of the beam splitter 180.

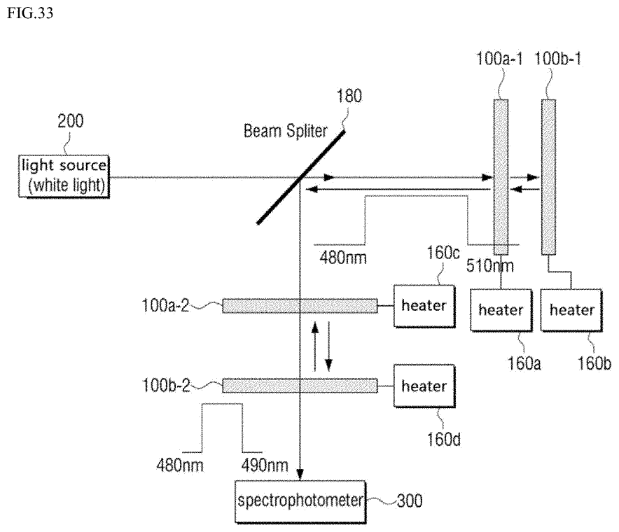

FIG. 33 illustrates a bandpass filter of the ninth example.

Referring to FIG. 33, the bandpass filter may include two right-hand circular polarizers 100a-1 and 100a-2, two left-hand circular polarizers 100b-1 and 100b-2, and four heaters 160a, 160b, 160c, 160d. Each of the four heaters 160a, 160d, 160c, and 160d may supply heat to the first and second right-hand circular polarizers 100a-1 and 100a-2 and the first and second left-hand circular polarizers 100b-1 and 100b-2, respectively. The wavelength bands of the light reflected by the first right-hand circular polarizer 100a-1 and the first left-hand circular polarizer 100b-1 may be identical to each other. In addition, the wavelength band of the light reflected by the second right-hand circular polarizer 100a-2 and the second left-hand circular polarizer 100b-2 may also be identical to each other. Each heater 160a, 160b, 160c, 160d may be set to the same temperature or may be set to different temperatures. The circularly polarized wavelength band of the right-hand circularly polarized filters 100a-1 and 100a-2 and the left-hand circularly polarized filters 100b-1 and 100b-2 may vary depending on the temperature of the heat supplied from each heater 160a, 160b, 160c, and 160d.

Each of the first right-hand circular polarizer 100a-1 and the first left-hand circular polarizer 100b-1 may reflect the left-hand circularly polarized light and the right-hand circularly polarized light, respectively, to reflect the unpolarized light having a specific passing wavelength band to the beam splitter 180. In addition, the second right-hand circular polarizer 100a-2 and the second left-hand circular polarizer 100b-2 may adjust bandwidth of the pass wavelength band. Detailed description will be omitted since the detailed operation of the bandpass filter is the same as described above.

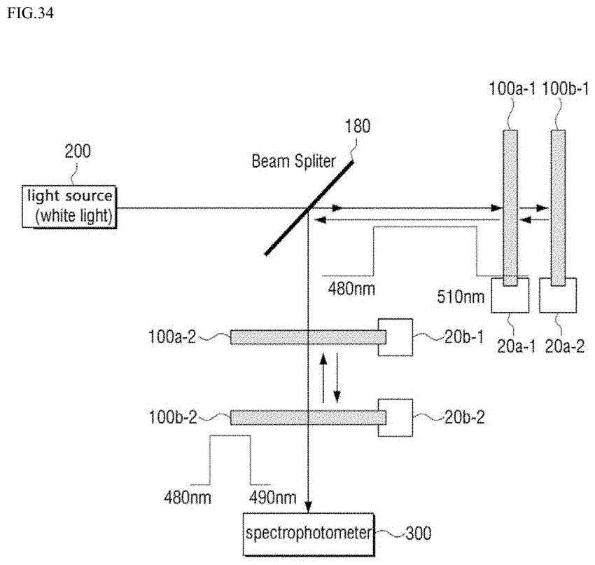

FIG. 34, the bandpass filter of the tenth example is illustrated.

Referring to FIG. 34, the bandpass filter may include right-hand circular polarizers 100a-1 and 100a-2 and left-hand circular polarizers 100b-1 and 100b-2 including a moving stage. Pitch gradients may be formed in the right-hand circular polarizers 100a-1 and 100a-2 and the left-hand circular polarizers 100b-1 and 100b-2. For example, the pitch gradient may be formed using a temperature, a concentration of a chiral material, a concentration of azo dyes, a conversion rate of cis-type by the amount or intensity of ultraviolet rays incident, a pitch distance depending on the size of the spacer, and the like.

Gradients of the first right-hand circular polarizer 100a-1 and the first left-hand circular polarizer 100b-1 may be formed the same ratio. In addition, gradients of the second right-hand circular polarizer 100a-2 and the second left-hand circular polarizer 100b-2 may also be formed the same ratio.

The first right-hand circular polarizer 100a-1 may be disposed on the 1-1 moving stage 20a-1, and the first left-hand circular polarizer 100b-1 may be disposed on the 1-2 moving stage 20a-2. The second right-hand circular polarizer 100a-2 may be disposed on the 2-1 moving stage 20b-1, and the second left-hand circular polarizer 100b-2 may be disposed on the 2-2 moving stage 20b-2. The 1-1 moving stage 20a-1 and the 1-2 moving stage 20a-2 may move the same distance. In this case, the 1-1 moving stage 20a-1 and the 1-2 moving stage 20a-2 may use one of the two moving stages to simultaneously move the first right-hand circular polarizer 100a-1 and the first left-hand circular polarizer 100b. In addition, the 2-1 moving stage 20b-1 and the 2-2 moving stage 20b-2 may also move the same distance. At this time, the 2-1 moving stage 20b-1 and the 2-2 moving stage 20b-2 may use one of the two moving stages to simultaneously move the second right-hand circular polarizer 100a-2 and the second left-hand circular polarizer 100b.

As described above, the first right-hand circular polarizer 100a-1 and the first left-hand circular polarizer 100b-1 respectively reflect the left-hand circularly polarized light and the right-hand circularly polarized light to reflect unpolarized light of a specific passing wavelength band to the beam splitter 180. In addition, the second right-hand circular polarizer 100a-2 and the second left-hand circular polarizer 100b-2 may adjust bandwidth of the pass wavelength band. Detailed description will be omitted since the detailed operation of the bandpass filter is the same as described above.

Meanwhile, the bandpass filter may include a rotator instead of a moving stage, and may include an optical waveguide instead of a beam splitter 180.

Meanwhile, the above-described bandpass filter with tunable wavelength includes a detector that may be used as a monochrometer, a tunable wavelength minor, or a spectrophotometer device.

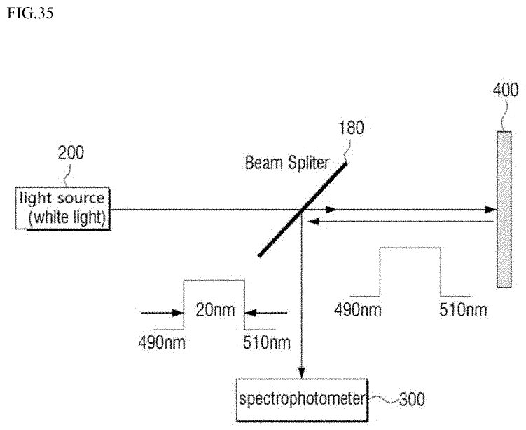

FIG. 35 illustrates a bandpass filter of the eleventh example.

Referring to FIG. 35, the bandpass filter may include a beam splitter 180 and a notch filter 400 including two layers of a left-hand and a right-hand circular polarizer. The light source 200 outputs light. The output light may be unpolarized light or linearly polarized light. Light output from the light source 200 may pass through the beam splitter 180. Light passed through the beam splitter 180 reaches the notch filter 400. The notch filter 400 may reflect the light of a specific wavelength band PBG among the reached light. Since the notch filter 400 includes a right-hand circularly polarized cholesteric liquid crystal and a left-hand circularly polarized cholesteric liquid crystal, the light reflected from the notch filter 400 has both left-hand circularly polarized component and a right-hand circularly polarized component. For example, the specific wavelength band may be between 490 nm and 510 nm. The light reflected by the notch filter 400 may be reflected by the beam splitter 180.

The spectrometer 300 may detect only light of a wavelength band of 490 nm to 510 nm of the light output from the light source 200. That is, the filter illustrated in FIG. 35 is a bandpass filter which passes only light of a wavelength band between 490 nm and 510 nm.

Meanwhile, an optical waveguide may be disposed instead of the beam splitter. That is, a bandpass filter for passing the light in the PBG region may be implemented by reflecting or separating the light reflected from the notch filter 400 by a beam splitter or an optical waveguide.

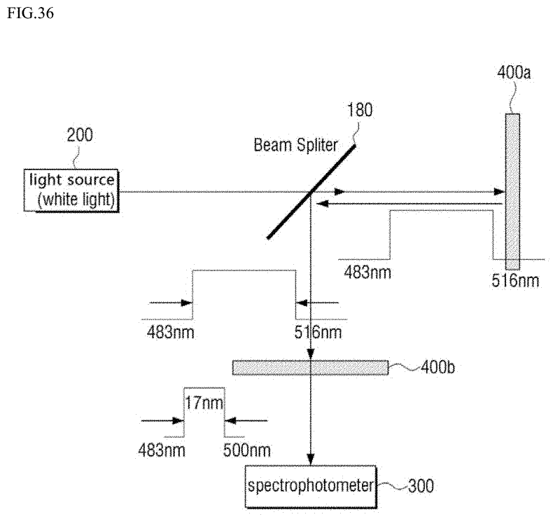

FIG. 36 illustrates a bandpass filter of the twelveth example.

Referring to FIG. 36, the bandpass filter may include notch filters 400a and 400b of a two-layer structure of two left-hand circular polarizer and right-hand circular polarizer. Light output from the light source 200 passes through the beam splitter 180 to reach the first notch filter 400a. The light of a specific wavelength among the light reaching the first notch filter 400a is reflected by the first notch filter 400a. As described above, since the notch filter includes a right-hand circularly polarized cholesteric liquid crystal and a left-hand circularly polarized cholesteric liquid crystal, the light reflected from the notch filter has both left-hand circularly polarized component and right-hand circularly polarized component. For example, a specific wavelength may be between 483 nm and 516 nm. The reflected light is reflected by the beam splitter 180 and reaches the second notch filter 400b.

Meanwhile, the wavelength band reflected by the first notch filter 400a may be different from the reflected wavelength band of the second notch filter 400b. For example, the wavelength band reflected by the first notch filter 400a may be between 483 nm and 516 nm, and the wavelength band reflected by the second notch filter 400b may be between 500 nm and 534 nm.

That is, the wavelength band of the light reaching the second notch filter 400b is light of between 483 nm and 516 nm. The second notch filter 400b reflects the light of between 500 nm and 534 nm. Therefore, the light passed through the second notch filter 400b is light of between 483 nm and 500 nm. Light passed through the second notch filter 400b may be detected by the spectrometer 300. A bandpass filter to adjust a transmitting band gap using the first notch filter 400a and the second notch filter 400b having different reflected wavelength bands may be implemented.

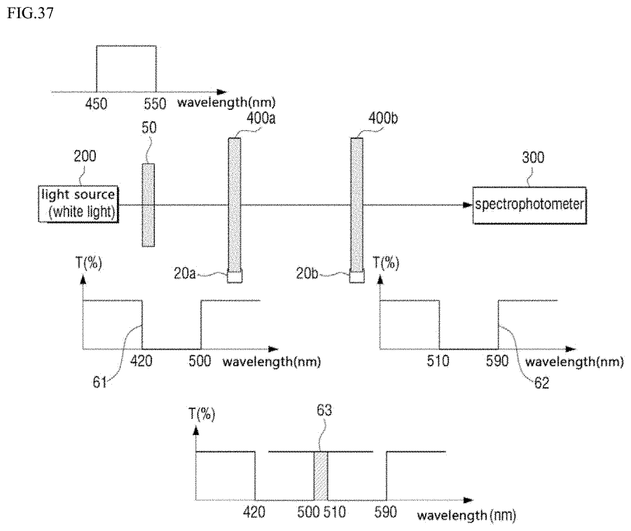

FIG. 37 illustrates a bandpass filter of the thirteenth example.

FIG. 37 illustrates a bandpass filter in which notch filters 400a and 400b having two pitch gradients formed are disposed in a line with the light source 200. In this case, the light source 200 may be a light source of a narrow wavelength region (for example, 450 nm to 550 nm region) or a light source of a wide wavelength region. In the case of a light source of a wide wavelength region, a filter that passes only light of a specific wavelength region may be used. For example, a fluorescence dichroic filter 50 (transmits only light of a specific wavelength region, for example, transmits only light of 450 nm to 550 nm) may be disposed after the light source to block unwanted light of a certain wavelength region. The first notch filter 400a and the second notch filter 400b may each include the first moving stage 20a and the second moving stage 20b, respectively. The light output from the light source 200 is emitted to various regions of the first notch filter 400a and the second notch filter 400b depending on the movement of each of the moving stages 20a and 20b so that the first notch filter 400a and the second notch filter 400b may reflect light in different PBG regions. For example, the first notch filter 400a moves the first moving stage 20a to be in a location reflecting light 61 between the wavelength band 420 nm and 500 nm, and the second notch filter 400b moves the second moving stage 20b to reflect the light 62 of the wavelength band between 510 nm and 590 nm.

The light output from the light source 200 passes through fluorescence dichroic filter 50 (only transmits light of 450 nm˜550 nm). Light in the region of 450 nm to 550 nm passed through the fluorescence dichroic filter reaches the first notch filter 400a. Therefore, the light passed through the first notch filter 400a is light in which components of the wavelength band between 420 nm and 500 nm are removed. The light of between 500 nm and 550 nm passed through the first notch filter 400a reaches the second notch filter 400b. The second notch filter 400b removes light of the wavelength band between 510 nm and 590 nm. Thus, light passed through the second notch filter 400b may include components 63 of the wavelength band between 500 nm and 510 nm. The filter including the moving stage may move the first moving stage 20a and the second moving stage 20b to operate as a bandpass filter with tunable wavelength having a bandwidth of 10 nm in the range of 450 nm to 550 nm.

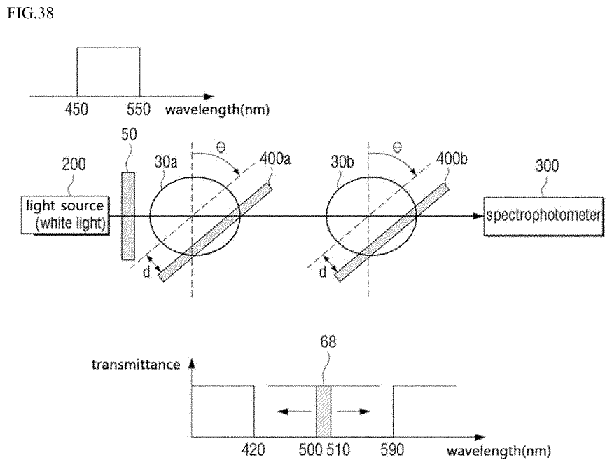

FIG. 38 illustrates a bandpass filter of the fourteenth example.

Referring to FIG. 38, a bandpass filter implemented with a first notch filter 400a including a first rotator 30a and a second notch filter 400b including a second rotator 30b is illustrated. Two notch filters 400a and 400b are disposed in line with the light source 200. In this case, the light source may be a light source of a narrow wavelength region (for example, 450 nm to 550 nm region) or a light source of a wide wavelength region. In the case of a light source of a wide wavelength region, a filter that transmits only light of a specific wavelength region may be used. For example, a fluorescence dichroic filter 50 (transmits only light of a specific wavelength region, for example, transmits only light of 450 nm to 550 nm) may be disposed after the light source to block unwanted light of a certain wavelength region.

As the first rotator 30a and the second rotator 30b rotate, respectively, the PBG locations of the first and second notch filters 400a and 400b may move to short wavelength, respectively, and the bandpass filter with tunable wavelength may be implemented by changing the rotation angle such that the changed PBG locations of the two notch filter are crossed. That is, a bandpass filter which transmits light 68 in a specific wavelength region may be implemented by crossing PBG locations of the first and second notch filters 400a and 400b. The movement of the location of the PBG by rotation is unrelated to the rotation direction, therefore, may be turned clockwise or counterclockwise.

In FIG. 38, the first notch filter 400a and the second notch filter 400b may each be a notch filter having a pitch gradient according to various methods. In addition, the first notch filter 400a and the second notch filter 400b may be disposed in a region spaced apart from the rotation axes of the first and second rotators 30a and 30b, respectively. The first and second rotators 30a and 30b may rotate at different angles.

In addition, in order to transmit only light of a specific wavelength after the light source of FIGS. 37 and 38, another filter may be used instead of the fluorescence dichroic filter (transmits light in a specific wavelength region only, for example, transmits light of 450 nm to 550 nm). For example, a long-pass filter (transmits only light above a certain wavelength, for example, 400 nm or more) or a short-pass filter (transmits only light below a certain wavelength, for example, 550 nm or less) may be appropriately included to block unwanted wavelength.

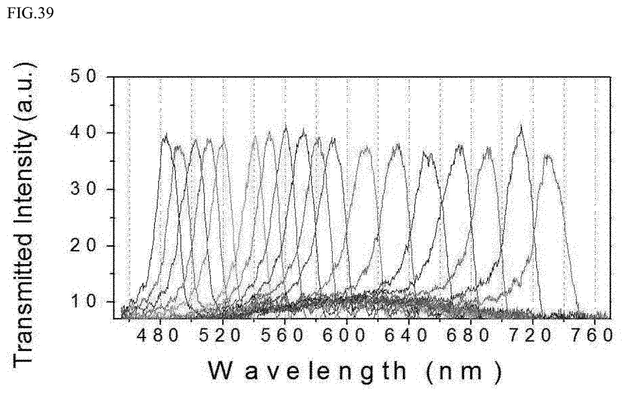

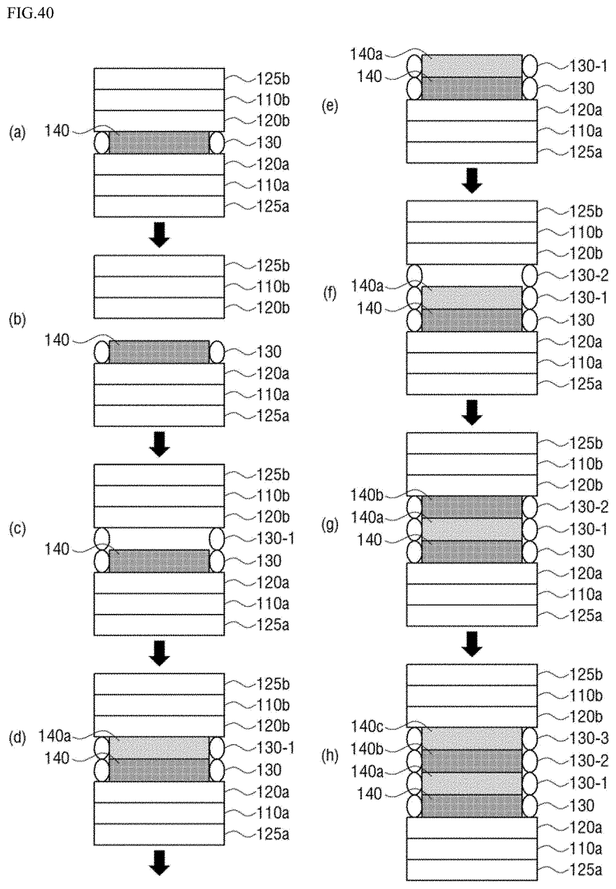

FIG. 39 illustrates an output waveform of a bandpass filter according to an example. As illustrated in FIG. 39, one bandpass filter may transmit various wavelength bands of light depending on various gradients formed in the right-hand circular polarizer and the left-hand circular polarizer. For example, the waveform of the bandpass filter illustrated in FIG. 39 shows that it may transmit light of continuous and various wavelength bands from a wavelength of about 460 nm to about 750 nm.

Various examples of the bandpass filter using the linear polarizer have been described. As described above, the example of the bandpass filter is not limited to the example illustrated in the drawings. A bandpass filter may be implemented by combining various linear polarizers, if a specific wavelength (or frequency) band can be transmitted using the various linear polarizers described above.

On the other hand, in the case of an anti-reflective coating in a wide wavelength range, for example, within the range of 400 nm to 1000 nm, 1% to 3% of the intensity of light may pass through the photonic band of the notch filter, depending on the quality of the anti-reflective coating. In the case of a low-power light source, 1% to 3% of transmitted light may be ignored in some cases, but may not be ignored in a precision optical sensor or a device, and when the light source is a high power laser, the characteristics of the bandpass filter or notch filter using the polarizer described above may be degraded because high power lasers have high energy such that some components of the light in the wavelength region which has to be reflected transmits the polarizer. Accordingly, there is a need for a filter having not only a 0% transmission effect that completely blocks within the photonic band of the notch filter, but also having 100% of excellent characteristics even when light of a high power laser is incident. For example, a high power laser may refer to a laser having a power of CW laser 30 mW or more. However, the above-described criterion is an example, and the criteria for classifying the high power laser may vary.

Hereinafter, a notch filter and a bandpass filter having excellent characteristics even when a high power laser is used as a light source, will be described. The bandpass filter and notch filter described below may also be used in a light source of a low power laser.

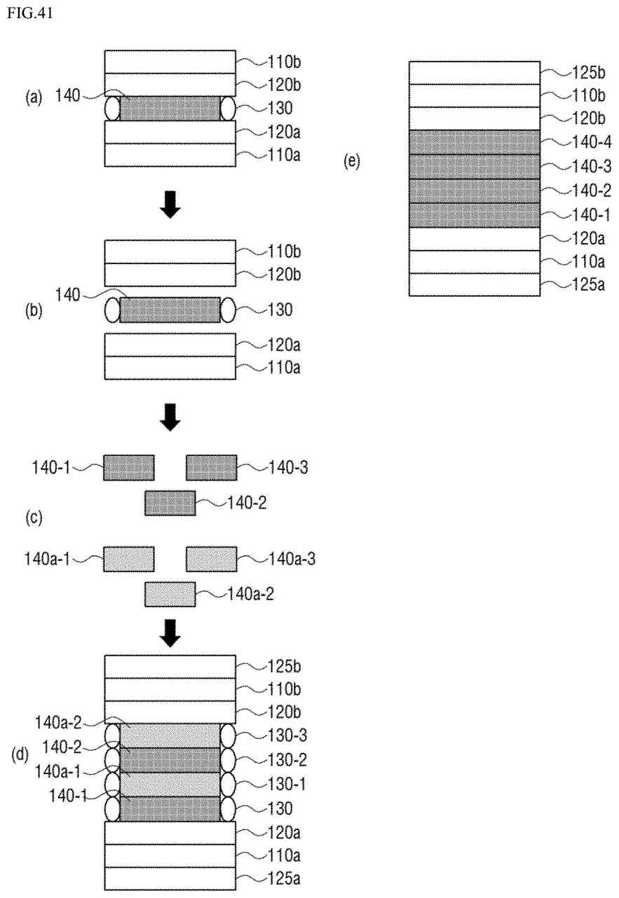

FIGS. 40 to 43 illustrate a method of implementing a filter including a plurality of cholesteric liquid crystal layers according to an example.

Referring to FIG. 40(a), an example of a filter is illustrated. One circular polarizer may have characteristics of a bandpass filter depending on the angle of the incident light. That is, the circular polarizer may be a filter.

The filter includes a pair of substrates 110a, 110b, polyimide layers 120a, 120b coated on one surface of each of the pair of the substrates 110a, 110b, a cholesteric liquid crystal layer 140 including a chiral material injected between the polyimide layers 120a, 120b. The cholesteric liquid crystal layer 140 is polymerized by ultraviolet rays or heat. The cholesteric liquid crystal may be a material that can be polymerized by ultraviolet rays or heat. The rubbing process may be performed to the polyimide layers 120a and 120b in some cases. In addition, antireflection AR layers 125a and 125b may be coated on the other surfaces of the pair of the substrates 110a and 110b. That is, the antireflection layers 125a and 125b may be coated on the outer surface of the filter. One substrate 110b coated with the polyimide layer 120b of the filter is removed.

FIG. 40(b) illustrates a view in which one substrate 110b coated with the polyimide layer 120b of the filter is removed. After one substrate 110b of the filter is removed, a cell is manufactured using a spacer 130-1.

FIG. 40(c) illustrates a device including a new cell. The cell is manufactured using the substrate 110b coated with the polyimide layer 120b and the new spacer 130-1. Then, a nematic liquid crystal and a chiral material are injected into the manufactured cell. After the chiral material is injected, the cholesteric liquid crystal layer is polymerized by ultraviolet rays or heat. The cholesteric liquid crystal may be a material that can be polymerized by ultraviolet rays or heat.

FIG. 40(d) illustrates a two-layer structured filter each having left-hand and right-hand circularly polarized light characteristics including a new cholesteric liquid crystal layer 140a by injecting a nematic liquid crystal and a chiral material into the manufactured cell. As described above, when the cholesteric liquid crystal layer 140 of FIG. 40(a) includes a levorotatory chiral material, the new cholesteric liquid crystal layer 140a includes a dextrorotatory chiral material. On the other hand, when the cholesteric liquid crystal layer 140 of FIG. 40(a) includes a dextrorotatory chiral material, the new cholesteric liquid crystal layer 140a includes a levorotatory chiral material. When the levorotatory chiral material is included, the cholesteric liquid crystal layer has right-hand circular polarization characteristics. And when the dextrorotatory chiral material is included, the cholesteric liquid crystal layer has left-hand circular polarization characteristics. The manufacturing order of the cholesteric liquid crystal layer of the left-hand circular polarization characteristics and the cholesteric liquid crystal layer of right-hand circular polarization characteristics may be variable. The concentration of chiral molecules injected into the existing cholesteric liquid crystal layer 140 and the new cholesteric liquid crystal layer 140a to match the location of the PBG may be adjustable. One substrate 110b coated with the polyimide layer 120b of the filter is removed.

FIG. 40(e) illustrates a view in which one substrate 110b coated with the polyimide layer 120b of the filter is removed. After one substrate 110b of the filter is removed, an additional cell is manufactured using a spacer 130-2.

FIG. 40(f) illustrates a device including an additional cell. The cell is manufactured using the substrate 110b coated with the polyimide layer 120b and a new spacer 130-2. Then, a nematic liquid crystal and a chiral material are injected into the manufactured cell. The cholesteric liquid crystal layer is polymerized by ultraviolet rays or heat.

FIG. 40(g) illustrates a filter including a new cholesteric liquid crystal layer 140b by injecting a nematic liquid crystal and a chiral material into the manufactured cell. As described above, one substrate 110b coated with the polyimide layer 120b of the filter is removed, and a nematic liquid crystal and a chiral material are injected into the cell between the spacer 130-3. The cholesteric liquid crystal layer 140b is polymerized by ultraviolet rays or heat.

FIG. 40(h) illustrates a four-layered filter sequentially having left-hand and right-hand circularly polarized light characteristics. That is, the four-layered filter includes from the lower part, disposed in the order of a cholesteric liquid crystal layer 140 having right-hand circular polarization characteristics, a cholesteric liquid crystal layer 140a having left-hand circular polarization characteristics, and a cholesteric liquid crystal layer 140b having right-hand circular polarization characteristics and a cholesteric liquid crystal layer 140c having a left-hand circular polarizer characteristics. Or may be disposed in the reverse order, such as the cholesteric liquid crystal layer 140 having left-hand circular polarization characteristics, the cholesteric liquid crystal layer 140a having right-hand circular polarization characteristics, the cholesteric liquid crystal layer 140b having left-hand circular polarization characteristics, and the cholesteric liquid crystal layer 140c having right-hand circular polarization characteristics.

In addition, the filter may be manufactured in other ways.

Referring to FIG. 41(a), an example of a filter is illustrated. The filter includes a pair of substrates 110a, 110b, polyimide layers 120a, 120b coated on one surface of each of the pair of the substrates 110a, 110b, and a cholesteric liquid crystal layer 140 including a chiral material injected between the polyimide layers 120a, 120b. The chiral material may be a levorotatory chiral material or a dextrorotatory chiral material. The cholesteric liquid crystal layer 140 may be formed by injecting a chiral dopant mixture between the spacer 130 and polymerizing by ultraviolet rays or heat. The rubbing process may be performed to the polyimide layers 120a and 120b in some cases. Each of the substrates 110a and 110b coated with the polyimide layers 120a and 120b is removed.

Referring to FIG. 41(b), a filter in which each substrate 110a and 110b is removed is illustrated. When each of the substrates 110a and 110b is removed, the polymerized cholesteric liquid crystal layer 140 may be obtained.

Referring to FIG. 41(c), a plurality of polymerized cholesteric liquid crystal layers in which the polymerized cholesteric liquid crystal layer is divided into several small pieces is illustrated. If the plurality of cholesteric liquid crystal layers 140-1, 140-2, and 140-3 obtained from the processes of FIGS. 41(a) and 41(b) are cholesteric liquid crystal layers having right-hand circular polarization characteristics, a cholesteric liquid crystal layer having left-hand circular polarization characteristics may also be obtained in the same manner. Alternatively, if the plurality of cholesteric liquid crystal layers 140-1, 140-2, and 140-3 obtained from the processes of FIGS. 41(a) and 41(b) are cholesteric liquid crystal layers having left-hand circular polarization characteristics, a cholesteric liquid crystal layer having right-hand circular polarization characteristics may also be obtained in the same manner. For the convenience of explanation, it is assumed that the plurality of cholesteric liquid crystal layers 140-1, 140-2, and 140-3 obtained from the processes of FIGS. 41(a) and 41(b) are liquid crystal layers having right-hand circular polarization characteristics. That is, FIG. 41(c) illustrates a plurality of cholesteric liquid crystal layers 140-1, 140-2, and 140-3 having right-hand circular polarization characteristics and a plurality of cholesteric liquid crystal layers 140a-1, 140a-2 and 140a-3 having left-hand circular polarization characteristics. FIG. 41(c) illustrates three cholesteric liquid crystal layers per different characteristics, however, cholesteric liquid crystal layers may be manufactured in the number of two or four. In addition, the cholesteric liquid crystal layers 140-1, 140-2, 140-3, 140a-1, 140a-2, and 140a-3 may be manufactured to have a certain chiral concentration or a pitch gradient. The filter may be manufactured by alternately stacking cholesteric liquid crystal layers having different characteristics.

FIG. 41(d) illustrates a filter manufactured by alternately stacking cholesteric liquid crystal layers having different characteristics. That is, the filter may include a pair of substrates 110a and 110b, polyimide layers 120a and 120b coated on one surface of each of the pair of the substrates 110a and 110b, cholesteric liquid crystal layers 140-1 and 140-2 having right-hand circular polarization characteristics and cholesteric liquid crystal layers 140a-1 and 140a-2 having left-hand circular polarization characteristics which are sequentially stacked alternately between the polyimide layers 120a and 120b, and spacers 130, 130-1, 130-2 and 130-3 disposed on the side surfaces of the cholesteric liquid crystal layers. If necessary, anti-reflective layers 125a and 125b may be coated on the other surfaces of the substrates 110a and 110b. Meanwhile, the filter may be manufactured by stacking a plurality of cholesteric liquid crystal layers having the same characteristics.

FIG. 41(e) illustrates a filter in which a plurality of cholesteric liquid crystal layers having the same characteristics is stacked. As illustrated in FIG. 41(e), the filter may be manufactured by stacking a plurality of cholesteric liquid crystal layers 140-1, 140-2, 140-3, and 140-4 having right-hand circular polarization characteristics. Alternatively, the filter may be manufactured by stacking a plurality of cholesteric liquid crystal layers 140a-1, 140a-2, 140a-3, and 140a-4 having left-hand circular polarization characteristics. Meanwhile, the cholesteric liquid crystal layer may be manufactured in other manners.

Referring to FIG. 42(a-1), a cell manufactured in another manner is illustrated. The cell may be manufactured by spin-coating a cholesteric liquid crystal 140 including a chiral material on a substrate 110a coated with a polyimide layer 120a. The cholesteric liquid crystal may be obtained by removing the substrate 110a coated with the polyimide layer 120a from the manufactured cell.

Referring to FIG. 42(b-1), the separated cholesteric liquid crystal 140 is illustrated. As described above, the cholesteric liquid crystal including the levorotatory chiral material has right-hand circular polarization characteristics with respect to the transmitted light, and the cholesteric liquid crystal including the dextrorotatory chiral material has left-circular polarization characteristics with respect to the transmitted light. Multiple cholesteric liquid crystals having different characteristics may be manufactured by dividing into a plurality of small pieces. As illustrated in FIG. 41(d), a filter may be manufactured by sequentially stacking cholesteric liquid crystals having different characteristics. Or as described in FIG. 41(e), a filter may be manufactured by stacking cholesteric liquid crystals having the same characteristics. On the other hand, the filter may be manufactured in other ways.

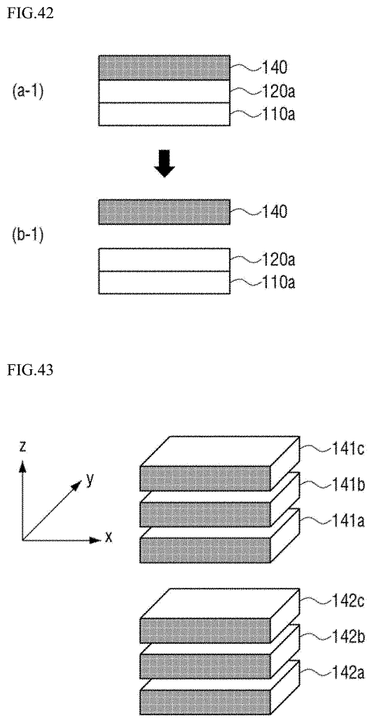

Referring to FIG. 43, a cholesteric liquid crystal divided into a plurality of pieces is illustrated. Similar to the description in FIG. 41(d), a filter may be manufactured by sequentially stacking cholesteric liquid crystal pieces having different characteristics. Or as described with reference to FIG. 41(e) a filter may be manufactured by stacking cholesteric liquid crystals having the same characteristics. When the cholesteric liquid crystal pieces are split, the cholesteric liquid crystal was split with the XY plane as the reference plane. A filter including a cholesteric liquid crystal layer may be manufactured by dividing a single cholesteric liquid crystal into multiple and stacking the same.

A filter including a plurality of cholesteric liquid crystal layers may have excellent filter performance even when high power laser light is input. That is, a filter including a relatively thick cholesteric liquid crystal layer may effectively block (or reflect) the light of a certain wavelength band even when high power laser light is input. Hereinafter, various examples of implementing a notch filter and a bandpass filter will be described.

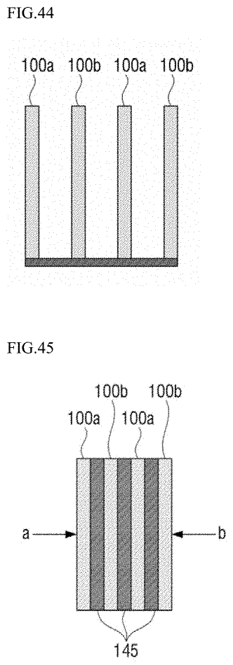

FIGS. 44 to 45 illustrate a structure of a filter including a plurality of cholesteric liquid crystal layers according to an example.

Referring to FIG. 44, a filter including a plurality of circular polarizers is illustrated. The filter includes a plurality of right-hand circular polarizers 100a and a plurality of left-hand circular polarizers 100b. Although two each of right-hand and left-hand circular polarizers 100a and 100b are illustrated in FIG. 44, the filter may include various numbers of right-hand and left-hand circular polarizers 100a and 100b. The outermost surface of each of the right-hand and left-hand circular polarizers 100a and 100b may be coated with an anti-reflective layer. In addition, the cholesteric liquid crystal layer included in the right-hand and left-hand circular polarizers 100a and 100b may include a chiral material having a certain concentration or a pitch gradient.

The right-hand circular polarizer 100a and the left-hand circular polarizer 100b of the filter may be alternately disposed at predetermined spaces. Therefore, an air layer may exist between the right-hand circular polarizer 100a and the left-hand circular polarizer 100b. When the right-hand circular polarizer 100a is disposed first, the circular polarizer may be disposed in the order of the right-hand circular polarizer 100a, the left-hand circular polarizer 100b, the right-hand circular polarizer 100a, and the left-hand circular polarizer 100b. Alternatively, when the left-hand circular polarizer 100b is disposed first, the circular polarizer may be disposed in the order of the left-hand circular polarizer 100b, the right-hand circular polarizer 100a, the left-hand circular polarizer 100b, and the right-hand circular polarizer 100a.

Referring to FIG. 45, a filter of another structure including a plurality of circular polarizers is illustrated.

The filter includes a plurality of right-hand circular polarizers 100a and left-hand circular polarizers 100b. The right-hand circular polarizer 100a may include a substrate coated with a polyimide layer on one surface thereof, and a cholesteric liquid crystal layer disposed between the polyimide layers and including a levorotatory chiral material. The left-hand circular polarizer 100b may include a substrate coated with a polyimide layer on one surface thereof, and a cholesteric liquid crystal layer disposed between the polyimide layers and including a dextrorotatory chiral material. The right-hand circular polarizer 100a and the left-hand circular polarizer 100b may be disposed alternately, and may include an index matching material layer 145 between the right-hand circular polarizer 100a and the left-hand circular polarizer 100b. The index matching material layer 145 is a material having a refractive index substantially identical to a substrate (e.g., glass), and it serves to prevent the light from being reflected when light passes through the right-hand circular polarizer 100a and then incident on the left-hand circular polarizer 100b, or when the light passes through the left-hand circular polarizer 100b and incident on the right-hand circular polarizer 100a disposed after it. For example, the index-matching material 145 may include a paste or index matching oil that does not absorb incident light.

Meanwhile, an anti-reflective layer may be coated on a surface other than the surface to which the index matching material layer 145 of the right-hand circular polarizer 100a and the left-hand circular polarizer 100b are attached. That is, the anti-reflective layer may be coated on both of the outermost sides a, b of the filter.

Various structures of a filter for high power laser light sources have been described. Hereinafter, specific examples of a notch filter and a bandpass filter will be described.

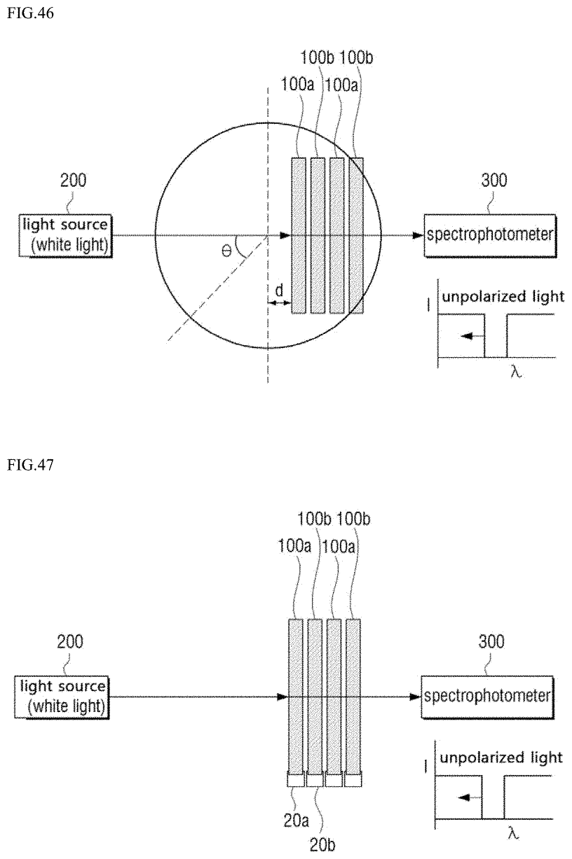

FIGS. 46 to 48 illustrate a notch filter including a plurality of cholesteric liquid crystals according to an example.

Referring to FIG. 46, a notch filter according to an example is illustrated. The notch filter may include a plurality of right-hand circular polarizers 100a and left-hand circular polarizers 100b. The notch filter including the plurality of right-hand circular polarizers 100a and the left-hand circular polarizers 100b may be manufactured by the method and structure described with reference to FIGS. 40 to 45. The plurality of right-hand circular polarizers 100a and the left-hand circular polarizers 100b may include a chiral material having a certain concentration or a pitch gradient.

Light is output from the light source 200. The light source 200 may include a high power laser. The light output from the light source 200 may be unpolarized light or linearly polarized light. Unpolarized light and linearly polarized light are composed of 50% of right-hand circular polarization and 50% of left-hand circular polarization, respectively.

The plurality of right-hand circular polarizers 100a reflects left-hand circularly polarized light of a specific wavelength PBG and transmits right-hand circularly polarized light. The left-hand circular polarizer 100b reflects the right-hand circularly polarized light of a specific wavelength and transmits the left-hand circularly polarized light. That is, since the left-hand circularly polarized light component in the PBG is removed from the right-hand circular polarizer 100a, and the right-hand circularly polarized light component is removed from the left-hand circular polarizer 100b, the light passed through the two polarizers has a waveform in which all wavelength in the PBG are removed. The light passed through the notch filter may be detected by the spectrometer 300.

On the other hand, the notch filter may include a rotator. The rotator may rotate the notch filter. The notch filter may be disposed in an area spaced apart from the rotation axis of the rotator by a predetermined distance d. The light source 200 may be disposed on the same axis as the diameter of the rotator, and the light source 200 and the spectrometer 300 may also be disposed on the same axis.

The rotator may change the angle of incidence of light incident on the notch filter or the location of the notch filter on which light is incident. Therefore, since the angle of incidence of light or the location of the notch filter of being incident varies depending on the rotation of the rotator, the PBG location of the notch filter may vary.

Meanwhile, the right-hand circular polarizer 100a and the left-hand circular polarizer 100b included in the notch filter may have a pitch gradient depending on the above-described various methods. The light output from the light source 200 may be emitted to various regions of the right-hand circular polarizer 100a and the left-hand circular polarizer 100b depending on the rotation of the rotator. The right-hand circular polarizer 100a and the left-hand circular polarizer 100b may reflect light of different wavelength (or frequency) bands depending on the region where light is emitted by a gradient of the pitch. Therefore, the notch filter may remove light of various wavelength bands depending on the rotation of the rotator. That is, the notch filter may vary the location of the PBG depending on the rotation of the rotator. For example, when the notch filter includes a chiral material of a certain concentration, the bandwidth of the tunable wavelength may be about 100 nm to 150 nm, and when includes a pitch gradient, the bandwidth of the tunable wavelength may be about 400 nm to 500 nm.

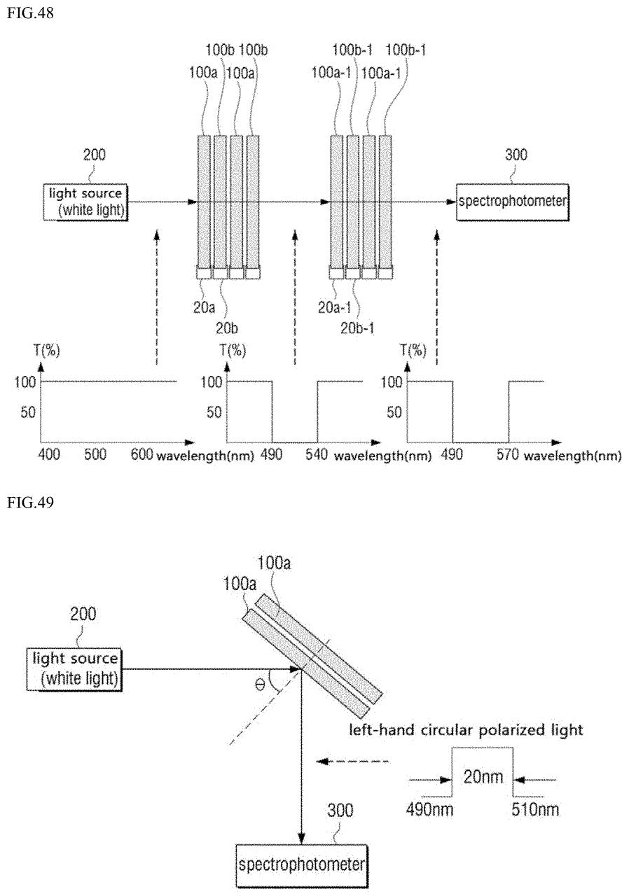

Referring to FIG. 47, a notch filter according to another example is illustrated. The notch filter may include a plurality of right-hand circular polarizers 100a and left-hand circular polarizers 100b in which a gradient of chiral concentration is formed. In addition, the right-hand circular polarizer 100a and the left-hand circular polarizer 100b may each include a first moving stage 20a and a second moving stage 20b, respectively. The first and second moving stages 20a and 20b may move the right-hand circular polarizer 100a and the left-hand circular polarizer 100b each of which has a gradient formed thereon. The first and second moving stages 20a and 20b may move the same distance. In some cases, the first and second moving stages 20a and 20b may move different distances.

As the first and second moving stages 20a and 20b move, the light output from the light source 200 may be emitted to various regions of the right-hand circular polarizer 100a and the left-hand circular polarizer 100b. Since the light output from the light source is emitted to various regions of the right-hand circular polarizer 100a and the left-hand circular polarizer 100b in which the gradient is formed, the notch filter may remove light of various wavelength bands. That is, in the notch filter, the location of the PBG may vary depending on the movement of the first and second moving stages 20a and 20b. The number of the right-hand circular polarizer 100a and the left-hand circular polarizer 100b included in the notch filter may be set variously if necessary.

Meanwhile, the notch filter may vary the bandwidth by using two sets of notch filters.

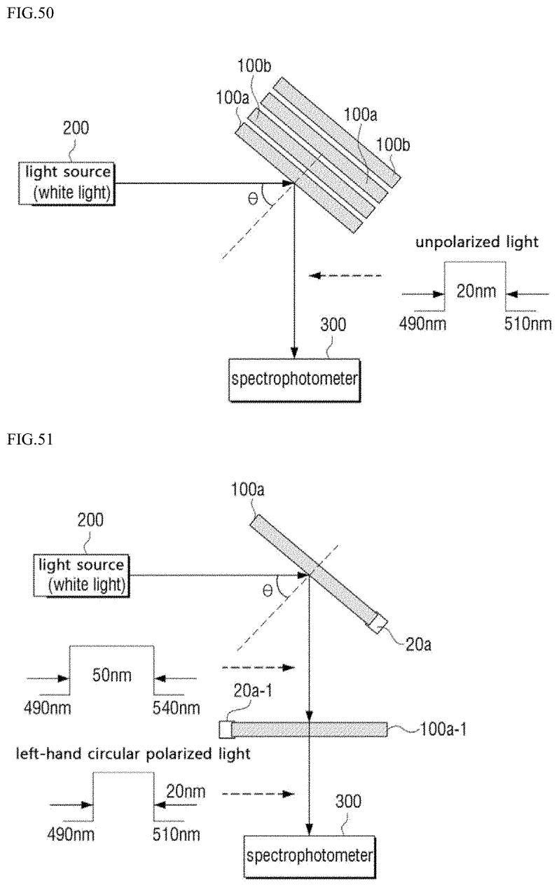

Referring to FIG. 48, a notch filter system capable of varying the wavelength and the bandwidth at the same time is illustrated. The notch filter system may include a first notch filter set and a second notch filter set. Each notch filter set may include a plurality of right-hand circular polarizers 100a, 100a-1 and left-hand circular polarizers 100b, 100b-1 in which a gradient of chiral concentration is formed. In addition, the right-hand circular polarizers 100a and 100a-1 and the left-hand circular polarizers 100b and 100b-1 may each include the first moving stages 20a and 20a-1 and the second moving stages 20b and 20b-1, respectively. The first and second moving stages 20a, 20a-1, 20b, and 20b-1 may each move the right-hand circular polarizers 100a and 100a-1 and the left-hand circular polarizers 100b and 100b-1 in which gradients are formed, respectively. The moving stages 20a, 20a-1, 20b, and 20b-1 of the first notch filter set and the second notch filter set may move the same distance. In some cases, the moving stages 20a and 20b of the first notch filter set and the moving stages 20a-1 and 20b-1 of the second notch filter set may move different distances.

The light output from the light source 200 may be emitted to various areas of right-hand circular polarizers 100a, 100a-1 and a left-hand circular polarizers 100b, 100b-1 depending on the movement of the first and second moving stages 20a, 20a-1, 20b, and 20b-1. As the light output from the light source is emitted to various regions of the right-hand circular polarizers 100a and 100a-1 and the left-hand circular polarizers 100b and 100b-1 in which gradient is formed, the notch filter system may remove light of various wavelength bands.

For example, the bandwidth of each of the first and second notch filter sets may be approximately 50 nm. The moving stages 20a and 20b of the first notch filter set may remove light of which a bandwidth from 490 nm to 540 nm is 50 nm. At the same time, the second notch filter set may remove light of which a bandwidth from 520 nm to 570 nm is 50 nm by the moving stages 20a-1 and 20b-1 of the second notch filter set. Thus, the light passed through the first and second notch filter sets may remove light of which a bandwidth from 420 nm to 570 nm is 80 nm. The bandwidth may vary from 50 nm to 100 nm depending on the movement of the moving stages 20a, 20b, 20a-1, and 20b-1 included in the first and second notch filter sets. The number of notch filter sets may be set variously if needed.

Various examples of implementing a notch filter have been described. Hereinafter, an example of implementing a bandpass filter will be described.

FIGS. 49 to 54 illustrate a bandpass filter including a plurality of cholesteric liquid crystals according to an example. The bandpass filter illustrated in FIGS. 49 to 54 does not include a beam splitter. In addition, the plurality of right-hand circular polarizers 100a and the left-hand circular polarizers 100b included in the bandpass filter may include a chiral material of a certain concentration or have a pitch gradient. In addition, the number of the right-hand circular polarizer 100a and the left-hand circular polarizer 100b included in the bandpass filter may be variously set depending on the output power of the light source.

Referring to FIG. 49, a bandpass filter according to an example is illustrated. The bandpass filter may include a plurality of right-hand circular polarizers 100a. A bandpass filter including a plurality of right-hand circular polarizers 100a may also be manufactured by the method and structure described with reference to FIGS. 40 to 45.

The light source 200 and the spectrometer 300 may be disposed to form a certain angle with the bandpass filter. As an example, as illustrated in FIG. 49, the angle formed by the light source 200—the bandpass filter—spectrometer 300 may be any angle depending on the purpose, for example, the angle at which light is incident may be 45 degrees. Light output from the light source 200 may be incident on the bandpass filter at a predetermined angle.

The light output from the light source 200 may be reflected by the bandpass filter and detected by the spectrometer 300. The light source may include a high power laser. The light output from the light source 200 may be unpolarized light or linearly polarized light. Unpolarized light and linearly polarized light are composed of 50% of right-hand circular polarization and 50% of left-hand circular polarization, respectively.

A plurality of right-hand circular polarizer 100a reflects left-hand circularly polarized light of a specific wavelength PBG and transmits right-hand circularly polarized light. Therefore, since the bandpass filter including the plurality of right-hand circular polarizers 100a reflects only the left-hand circularly polarized light component in the PBG, the spectrometer 300 may detect a waveform in which only the left-hand circularly polarized light of a predetermined band is passed.

Meanwhile, a bandpass filter including a plurality of left-hand circular polarizers may also be implemented. Since the bandpass filter including the plurality of left-hand circular polarizers 100a reflects only the right-hand circularly polarized light component in the PBG, the spectrometer 300 may detect a waveform in which only the right-hand circularly polarized light of a predetermined band is passed.

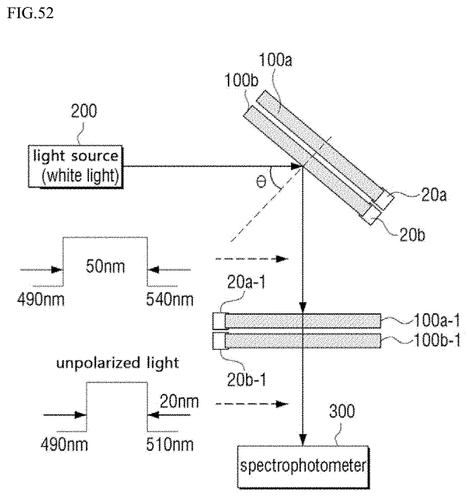

Referring to FIG. 50, a bandpass filter according to another example is illustrated. The bandpass filter may include a plurality of right-hand circular polarizers 100a and left-hand circular polarizers 100b. Each of the left-hand and right-hand circular polarizers 100a and 100b may have a pitch of a predetermined concentration or may have a pitch gradient by various methods of the above-described examples. In addition, a bandpass filter including a plurality of right-hand circular polarizers 100a and left-hand circular polarizers 100b may also be manufactured by the method and structure described with reference to FIGS. 40 to 45.

The light source 200 and the spectrometer 300 are disposed to form a certain angle with the bandpass filter so that the light reflected by the bandpass filter may be detected by the spectrometer 300. The light source may include a high power laser. The plurality of right-hand circular polarizers 100a reflects left-hand circularly polarized light of a specific wavelength PBG and transmits right-hand circularly polarized light. The plurality of left-hand circular polarizers 100b reflects right-hand circularly polarized light of a specific wavelength and transmits left-hand circularly polarized light. That is, since the left-hand circularly polarized light component in the PBG is reflected by the right-hand circular polarizer 100a and the right-hand circularly polarized light component is reflected by the left-hand circular polarizer 100b, the light reflected by the two polarizers may have a waveform which reflected all wavelengths in the PBG. That is, the spectrometer 300 may detect a waveform in which unpolarized light of a predetermined band is passed.

On the other hand, the bandpass filter may include a moving stage so that the location of the photonic band gap is matched each other, and the wavelength of the bandpass filter is tunable by moving the location.

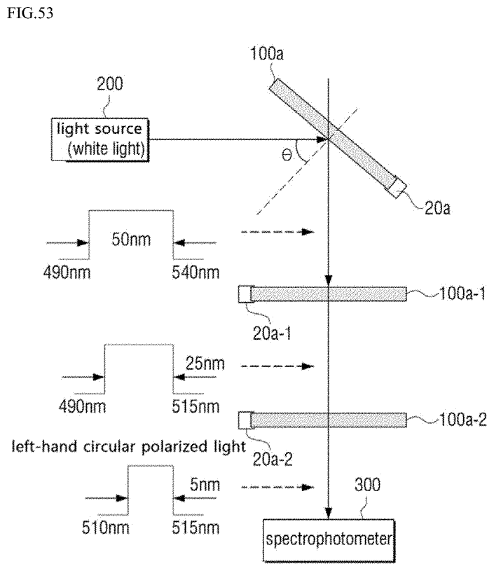

Referring to FIG. 51, a bandpass filter according to another example is illustrated.

The bandpass filter may include two right-hand circular polarizers 100a and 100a-1. The first right-hand circular polarizer 100a reflects left-hand circularly polarized light of a specific wavelength from the light output of the light source 200. In one example, the specific wavelength may be between 490 nm and 540 nm. The reflected left-hand circularly polarized light reaches the second right-hand circular polarizer 100a-1.

On the other hand, the polarized wavelength band of the second right-hand circular polarizer 100a-1 may be different from the wavelength band of the first right-hand circular polarizer 100a. In an example, the wavelength band of the second right-hand circular polarizer 100a-1 may be between 510 nm and 560 nm. The wavelength band of the light reaching the second right-hand circular polarizer 100a-1 is left-hand circularly polarized light of between 490 nm and 540 nm. The second right-hand circular polarizer 100a-1 reflects left-hand circularly polarized light of between 510 nm and 560 nm. Accordingly, the light passed through the second right-hand circular polarizer 100a-1 is left-hand circularly polarized light of between 490 nm and 510 nm. Therefore, the bandwidth of the light may be reduced by the second right-hand circular polarizer 100a-1.

As described above, the bandpass filter may include a left-hand circular polarizer instead of a right-hand circular polarizer. If the wavelength bands are identical to each other, the light passed through the bandpass filter including the left-hand circular polarizer is right-hand circularly polarized light of between 490 nm and 510 nm.

On the other hand, the first right-hand circular polarizer 100a and the second right-hand circular polarizer 100a-1 may include moving stages 20a and 20a-1, respectively. When the first right-hand circular polarizer 100a and the second right-hand circular polarizer 100a-1 are moved by the moving stages 20a and 20a-1, the wavelength band detected by the spectrometer 300 may be changed. In addition, the bandpass filter may include the above-described rotator instead of the moving stages 20a and 20a-1 to rotate the first right-hand circular polarizer 100a.

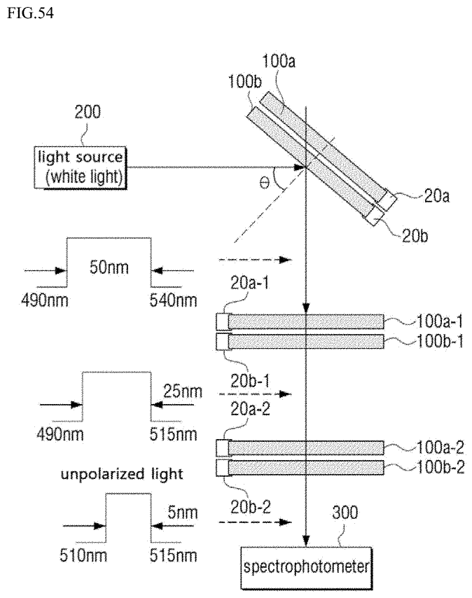

Referring to FIG. 52, a bandpass filter according to another example is illustrated.

The bandpass filter includes a reflector including a first right-hand circular polarizer 100a and a first left-hand circular polarizer 100b, and a band cutting unit including a second right-hand circular polarizer 100a-1, and a second left-hand circular polarizer 100b-1. Each of the left-hand and right-hand circular polarizers 100a, 100b, 100a-1, and 100b-1 may have a pitch of a predetermined concentration or may have a pitch gradient according to the above-described various examples. The first right-hand circular polarizer 100a of the reflector reflects left-hand circularly polarized light of a specific wavelength and the first left-hand circular polarizer 100b reflects the right-hand circularly polarized light having the same specific wavelength from the light output of the light source 200. Therefore, the light reflected by the reflector is unpolarized light. In one example, the specific wavelength may be between 490 nm and 540 nm. The reflected unpolarized light reaches the band cutting unit.

On the other hand, the polarized wavelength band in the band cutting unit may be different from the wavelength band of the reflector. In an example, the wavelength bands of the second right-hand circular polarizer 100a-1 and the second left-hand circular polarizer 100b-1 may be between 510 nm and 560 nm. The wavelength band of light reaching the band cutting unit is unpolarized light of between 490 nm and 540 nm. The second right-hand circular polarizer 100a-1 of the band cutting unit reflects left-hand circularly polarized light of between 510 nm and 560 nm, and the second left-hand circular polarizer 100b-1 reflects right-hand circularly polarized light of between 510 nm and 560 nm. Accordingly, the light passed through the second right-hand circular polarizer 100a-1 and the second left-hand circular polarizer 100b-1 is unpolarized light of between 490 nm and 510 nm.

Meanwhile, the right-hand circular polarizers 100a and 100a-1 and the left-hand circular polarizers 100b and 100b-1 may each include moving stages 20a, 20a-1, 20b and 20b-1, respectively. When the first right-hand circular polarizer 100a, the first left-hand circular polarizer 100b, the second right-hand circular polarizer 100a-1 and the second left-hand circular polarizer 100b-1 are moved by the moving stages 20a, 20b, 20a-1, and 20b-1, the wavelength band detected by the spectrometer 300 may be changed. In addition, the bandpass filter may rotate the reflector and the band cutting unit by including the above-mentioned rotator instead of the moving stages 20a, 20a-1, 20b, and 20b-1.

Referring to FIG. 53, a bandpass filter according to another example is illustrated. The bandpass filter may include a reflector including a first right-hand circular polarizer 100a and a band cutting unit including second and third right-hand circular polarizers 100a-1 and 100a-2. Each of the right-hand circular polarizers 100a, 100a-1, and 100a-2 may have a pitch of a predetermined concentration or may have a pitch gradient by the various examples described above. The left circular polarizing light of a specific wavelength from the light output of the light source is reflected by the first right circular polarizer 100a. In one example, the specific wavelength may be between 490 nm and 540 nm. The reflected left-hand circularly polarized light reaches the band cutting unit.

On the other hand, the polarized wavelength band of the second and third circular polarizers 100a-1, 100a-2 of the band cutting unit may be different from each other. In an example, the wavelength band of the second right-hand circular polarizer 100a-1 may be between 515 nm and 560 nm, and the wavelength band of the third right-hand circular polarizer 100a-2 may be between 460 nm and 510 nm. The wavelength band of light reaching the band cutting unit is left-hand circularly polarized light of between 490 nm and 540 nm. The second right-hand circular polarizer 100a-1 reflects left-hand circularly polarized light of between 515 nm and 560 nm. Accordingly, the light passed through the second right-hand circular polarizer 100a-1 is left-hand circularly polarized light of between 490 nm and 515 nm. The third right-hand circular polarizer 100a-2 reflects left-hand circularly polarized light of between 460 nm and 510 nm. Accordingly, the light passed through the third right-hand circular polarizer 100a-2 is left-hand circularly polarized light of between 510 nm and 515 nm. An ideal bandpass filter may be implemented by removing both opposite sides of the bandwidth from the band cutting unit of the bandpass filter.

As described above, the bandpass filter may include a plurality of left-hand circular polarizers instead of a plurality of right-hand circular polarizers. If the wavelength bands are identical to each other, the light passed through the bandpass filter including the plurality of left-hand circular polarizers is right-hand circularly polarized light of between 510 nm and 515 nm.

On the other hand, each of the right-hand circular polarizers 100a, 100a-1, 100a-2 may include a moving stages 20a, 20a-1, 20a-2. When the right-hand circular polarizers 100a, 100a-1, and 100a-2 are appropriately moved by the moving stages 20a, 20a-1, and 20a-2, the wavelength band detected by the spectrometer 300 may be changed. In addition, the bandpass filter may include the above-described rotator instead of the moving stage 20a-1 and 20a-2 to rotate the second and the third right-hand circular polarizer 100a-1 and 100a-2.

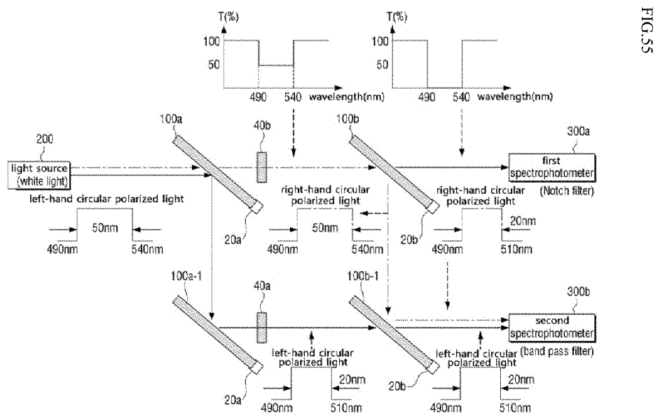

Referring to FIG. 54, a bandpass filter according to another example is illustrated.

The bandpass filter may include a reflector including a first right-hand circular polarizer 100a and a first left-hand circular polarizer 100b, a first band cutting unit including a second right-hand circular polarizer 100a-1 and a second left-hand circular polarizer 100b-1, a second band cutting unit including a third right-hand circular polarizer 100a-2 and a third left-hand circular polarizer 100b-2. Each of the right-hand circular polarizers 100a, 100a-1 and 100a-2 and the left-hand circular polarizers 100b, 100b-1 and 100b-2 may have a pitch of a certain concentration or a pitch gradient by the various examples described above. The left-hand and right circularly polarized light of a specific wavelength from the light output of the light source 200 is reflected by the first right-hand and left-hand circular polarizer 100a and 100b of the reflector. Therefore, the light reflected by the reflector is unpolarized light. In one example, the specific wavelength may be between 490 nm and 540 nm. The reflected unpolarized light reaches the first band cutting unit.

On the other hand, the wavelength band polarized in the first band cutting unit may be different from the wavelength band of the reflector. In an example, the wavelength bands of the second right-hand circular polarizer 100a-1 and the second left-hand circular polarizer 100b-1 may be between 515 nm and 560 nm. The wavelength band of light reaching the first band cutting unit is unpolarized light of between 490 nm and 540 nm. The second right-hand circular polarizer 100a-1 of the first band cutting unit reflects left-hand circularly polarized light of between 515 nm and 560 nm, and the second left-hand circular polarizer 100b-1 reflects right-hand circularly polarized light of between 515 nm and 560 nm. Therefore, the light passed through the first band cutting unit is unpolarized light of between 490 nm and 515 nm. The light passed through the first band cutting unit reaches the second band cutting unit.

On the other hand, the wavelength band polarized in the second band cutting unit may be different from the wavelength bands of the reflector and the first band cutting unit. In an example, the wavelength bands of the third right-hand circular polarizer 100a-2 and the third left-hand circular polarizer 100b-2 may be between 460 nm and 510 nm. The wavelength band of light reaching the second band cutting unit is unpolarized light of between 490 nm and 515 nm. The third right-hand circular polarizer 100a-2 of the second band cutting unit reflects left-hand circularly polarized light of between 460 nm and 510 nm, and the third left-hand circular polarizer 100b-2 reflects right-hand circularly polarized light of between 460 nm and 510 nm. Thus, the light passed through the second band cutting unit is unpolarized light of between 510 nm and 515 nm.

On the other hand, each of the right-hand circular polarizers 100a, 100a-1, 100a-2 and the left-hand circular polarizers 100b, 100b-1, 100b-2 may include moving stages 20a, 20a-1, 20a-2, 20b, 20b-1, 20b-2. When each of the polarizers 100a, 100a-1, 100a-2, 100b, 100b-1 and 100b-2 is moved by the moving stages 20a, 20a-1, 20a-2, 20b, 20b-1 and 20b-2 properly, the wavelength band detected by the spectrometer 300 may be changed. In addition, the bandpass filter may include the rotator described above instead of the moving stage 20a-1, 20a-2, 20b, 20b-1 and 20b-2 to rotate the right-hand circular polarizers 100a, 100a-1, 100a-2 and the left-hand circular polarizers 100b, 100b-1, 100b-2.

Examples of implementing a bandpass filter have been described. The following describes a composite filter that includes the functions of a notch filter and a bandpass filter.

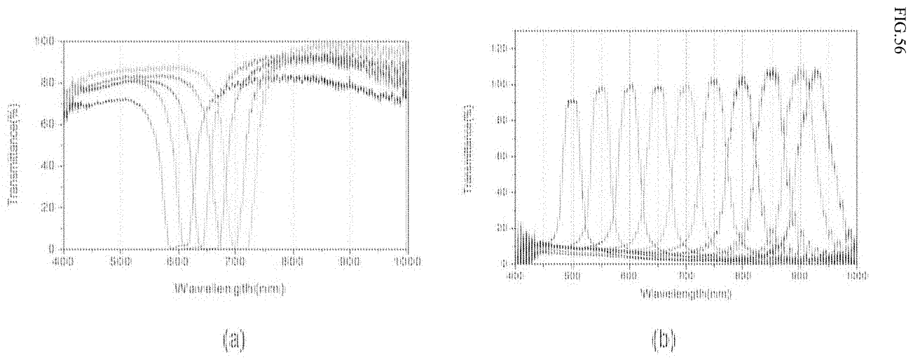

FIG. 55 illustrates a composite filter including a bandpass filter and a notch filter, according to an example.

Referring to FIG. 55, the composite filter includes first and second right-hand circular polarizers 100a, 100a-1, first and second left-hand circular polarizers 100b, 100b-1, and first and second switches 40a, 40b. The first and second switches 40a and 40b perform a function of passing or blocking incident light depending on/off.

The light source 200, the first spectrometer 300a, the first right-hand circular polarizer 100a, the second switch 40b, and the first left-hand circular polarizer 100b may be disposed on the same axis. The second spectrometer 300b, the second right-hand circular polarizer 100a-1, the first switch 40a, and the second left-hand circular polarizer 100b-1 may also be disposed on the same axis.

The first and second right-hand circular polarizers 100a and 100a-1 and the first and second left-hand circular polarizers 100b and 100b-1 may be disposed to form a certain angle with respect to the incident light axis to be incident so that the light in a specific wavelength range is reflected and incident to a device located next on the optical path. The second right-hand circular polarizer 100a-1 may be disposed at a location where light reflected from the first right-hand circular polarizer 100a is incident, and the second left-hand circular polarizer 100b-1 may be disposed at a location where light reflected from the first left-hand circular polarizer 100a is incident. The light output from the light source 200 may reach the first right-hand circular polarizer 100a. The first spectrometer 300a detects light passed through the first left-hand circular polarizer 100b, and the second spectrometer 300b detects light passed through the second left-hand circular polarizer 100b-1 and the light reflected by the second left-hand circular polarizer 100b-1.

Firstly, the case of the first switch 40a is turned off and the second switch 40b is turned on will be described.

When the first switch 40a is turned off, the light which is reflected from the second right-hand circular polarizer 100a-1, passes through the second left-hand circular polarizer 100b-1 and reaches the second spectrometer 300b is blocked. Accordingly, a first path which the light reaches the first spectrometer 300a through the light source 200, the first right-hand circular polarizer 100a, and the first left-hand circular polarizer 100b, and the second path which the light reaches the second spectrometer 300b through the light source 200, the first left-hand circular polarizer 100b, and the second left-hand circular polarizer 100b-1 are formed.

The first right-hand circular polarizer 100a reflects left-hand circularly polarized light of a specific wavelength band. If the specific wavelength band is between 490 nm and 540 nm, the light passed through the first right-hand circular polarizer 100a may have a waveform in which components of the left-hand circularly polarized light of 490 nm to 540 nm band are removed. The light passed through the first right-hand circular polarizer 100a reaches the first left-hand circular polarizer 100b.

The first left-hand circular polarizer 100b reflects the right-hand circularly polarized light of the specific wavelength band. If the specific wavelength band is between 490 nm and 540 nm, the light passed through the first left-hand circular polarizer 100b may have a waveform in which components of the right-hand circularly polarized light of 490 nm to 540 nm band are removed. Therefore, the light detected by the first spectrometer 300a via the first right-hand circular polarizer 100a and the first left-hand circular polarizer 100b may have a waveform in which all light components between 490 nm and 540 nm are removed. Therefore, the first spectrometer 300a may detect a waveform of the light passed through the notch filter.

In the case of the second path, the light passed through the first right-hand circular polarizer 100a reaches the first left-hand circular polarizer 100b with a waveform from which components of the left-hand circularly polarized light of 490 nm to 540 nm band are removed. Only right-hand circularly polarized light of between 490 nm and 540 nm is reflected by the first left-hand circular polarizer 100b and the light heads to the second left-hand circular polarizer 100b-1. If the reflected wavelength band of the second left-hand circular polarizer 100b-1 is between 460 nm and 510 nm, the light reflected by the second left-hand circular polarizer 100b-1 reflects only components of right-hand circularly polarized light of 490 nm to 510 nm band. Therefore, the bandwidth of the wavelength of the light reflected by the second left-hand circular polarizer may be reduced. The light reflected by the second left-hand circular polarizer 100b-1 heads to the second spectrometer 300b. Accordingly, the second spectrometer 300b may detect the waveform of the light of the second path passed through the right-hand circularly polarized bandpass filter.

Next, a case which the first switch 40a is turned on and the second switch 40b is turned off will be described.

When the second switch 40b is turned off, the light reaching the first left-hand circular polarizer 100b and the first spectrometer 300b is blocked. Therefore, the third path is formed which the light reaches the second spectrometer 300b through the light source 200, the first right-hand circular polarizer 100a, the second right-hand circular polarizer 100a-1, and the second left-hand circular polarizer 100b-1.

In the third path, the first right-hand circular polarizer 100a reflects left-hand circularly polarized light of a specific wavelength band. If the specific wavelength band is between 490 nm and 540 nm, the light reflected from the first right-hand circular polarizer 100a includes only components of the left-hand circularly polarized light of 490 nm to 540 nm band. The second right-hand circular polarizer 100a-1 may reflect left-hand circularly polarized light of a wavelength band different from that of the first right-hand circular polarizer 100a. When the wavelength band of the second right-hand circular polarizer 100a-1 is between 460 nm and 510 nm, the light reflected by the second right-hand circular polarizer 100a-1 includes only components of the left-hand circularly polarized light of 490 nm to 510 nm band. Therefore, the bandwidth of the wavelength of the light reflected by the second right-hand circular polarizer 100a-1 may be reduced. The light reflected by the second right-hand circular polarizer 100a-1 reaches the second left-hand circular polarizer 100b-1.

The second left-hand circular polarizer 100b-1 may reflect right-hand circularly polarized light of a wavelength band different from that of the first left-hand circular polarizer 100b. Since the light incident on the second left-hand circular polarizer 100b-1 reflects only components of right-hand circularly polarized light in the range of 490 nm to 510 nm, therefore, left-hand circularly polarized light reflected by the second right-hand circular polarizer 100a-1 and incident on the second left-hand circular polarizer 100b-1 passes through without any effect. Therefore, the light detected by the second spectrometer may have a waveform including only the left-hand circularly polarized light component between 490 nm and 510 nm. Therefore, the second spectrometer 300b may detect a waveform of light of the left-hand circularly polarized third path which passed through the bandpass filter.

Finally, the case which both the first and second switches 40a and 40b are turned on will be described.

The light output from the light source 200 forms a first path which the light passes through the first right-hand circular polarizer 100a and the first left-hand circular polarizer 100b. The waveform of the light passed through the first path is the same as that of the case which the first switch 40a is turned off, and the second switch 40b is turned on. Therefore, the first spectrometer 300a may detect a waveform of light which passed through the notch filter.

The light output from the light source 200 forms a second path which the light passes through the first right-hand circular polarizer 100a, the first left-hand circular polarizer 100b, and the second left-hand circular polarizer 100b-1. Accordingly, the second spectrometer 300b may detect a waveform of light of the second path which passed through the right-hand circularly polarized bandpass filter.

At the same time, the light output from the light source 200 forms a third path which the light passes through the first right-hand circular polarizer 100a, the second right-hand circular polarizer 100a-1, and the second left-hand circular polarizer 100b-1. The second spectrometer 300b may detect a waveform of light of the third path which the light passed through the left-hand circularly polarized bandpass filter. Therefore, the second spectrometer 300b detects the waveform in the wavelength range of 490 nm to 510 nm, which is the combination of the right-hand circularly polarized light incident through the second path and the left-hand circularly polarized light incident through the third path, passed through the unpolarized bandpass filter. Therefore, when both the first and second switches 40a and 40b are turned on, the first spectrometer 300a may detect the waveform of the light passed through the notch filter, and at the same time, the second spectrometer 300b may detect the waveform of the light passed through the unpolarized bandpass filter.

Each of the first and second right-hand circular polarizers 100a and 100a-1 and the first and second left-hand circular polarizers 100b and 100b-1 may be connected to the moving stages 20a and 20b to move locations. In addition, the cholesteric liquid crystal layers included in the first and second right-hand circular polarizers 100a and 100a-1 and the first and second left-hand circular polarizers 100b and 100b-1 include a chiral material having a certain concentration or a pitch gradient. Therefore, the composite filter may change the location of the notch filter and the location and width of the band of the bandpass filter by the moving stage. On the other hand, in the case of using only the first and second right-hand circular polarizers 100a and 100a-1 or only the first and second left-hand circular polarizers 100b and 100b-1 in the above-described configuration of the composite filter, a transmission bandpass filter may be implemented.

FIG. 56 illustrates an output waveform of a filter according to an example.

FIG. 56(a) illustrates the waveform of the notch filter. As illustrated in FIG. 56(a), the notch filter may change the wavelength and may remove light components almost completely in the band region.

FIG. 56(b) illustrates the waveform of the bandpass filter. As illustrated in FIG. 56(b), the bandpass filter may change the wavelength and shows a waveform close to the ideal waveform.

While this disclosure includes specific examples and drawings, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. A notch filter comprising:
a right-hand circular polarizer including a cholesteric liquid crystal CLC layer including a levorotatory chiral material of a predetermined concentration to reflect light of a left-hand circular component of a predetermined frequency band among the light output from a light source; and
a left-hand circular polarizer including a cholesteric liquid crystal CLC layer including a dextrorotatory chiral material of a predetermined concentration to reflect light of a right-hand circular component of the predetermined frequency band among the light passed through the right-hand circular polarizer.

13. A notch filter comprising:
a pair of substrates;
a polyimide PI layer coated on one surface of each of the pair of the substrates;
an anti-reflective layer coated on the other surface of each of the pair of the substrates;
a plurality of first and second spacers disposed to secure a space between the polyimide PI layer;
a first cholesteric liquid crystal CLC layer which is disposed on the space secured by the first spacer and having right-hand circular polarization characteristics of including a levorotatory chiral material of a predetermined concentration to reflect light of a left-hand circular component of a predetermined frequency band and to transmit light of a right-hand circular component among the light output from a light source; and
a second cholesteric liquid crystal CLC layer which is disposed on the space secured by the second spacer and having left-hand circular polarization characteristics of including a dextrorotatory chiral material of a predetermined concentration to reflect light of a right-hand circular component of a predetermined frequency band and to transmit light of a left-hand circular component among the light output from a light source.

14. A notch filter comprising:
a substrate;
a polyimide PI layer coated on one surface of the substrate;
a first cholesteric liquid crystal layer CLC spin-coated on the polyimide layer, having right-hand circular polarization characteristics, including a levorotatory chiral material of a predetermined concentration to reflect light of a left-hand circular component of a predetermined frequency band among the light output from a light source; and
a second cholesteric liquid crystal layer CLC spin-coated on the first cholesteric liquid crystal layer, having left-hand circular polarization characteristics and including a dextrorotatory chiral material of a predetermined concentration to reflect light of a left-hand circular component of a predetermined frequency band among light output from a light source.

15. A bandpass filter comprising:
a beam splitter for transmitting the light output from a light source; and
a circular polarizer including one of a right-hand circular polarizer including a cholesteric liquid crystal CLC layer including a levorotatory chiral material of a predetermined concentration to reflect light of left-hand circular component of a predetermined frequency band among light passed through the beam splitter, or a left-hand circular polarizer including a cholesteric liquid crystal CLC layer including a dextrorotatory chiral material of a predetermined concentration to reflect light of right-hand circular component of a predetermined frequency band among the light passed through the beam splitter, and
wherein the beam splitter reflects the light of the left-hand circular component of the predetermined frequency band reflected by the circular polarizer to convert into light of the right-hand circular component, or reflect the light of the right-hand circular component of the predetermined frequency band reflected by the circular polarizer to convert into light of the left-hand circular component.

16. A filter comprising:
a plurality of right-hand circular polarizers including a pair of substrates, a polyimide PI layer coated on one surface of each of the pair of the substrates, an anti-reflective AR layer coated on the other surface of each of the pair of the substrates, a plurality of spacers disposed to secure a space between the polyimide PI layer, and a cholesteric liquid crystal CLC layer disposed on the space secured by the spacers and including a levorotary chiral material of a predetermined concentration; and
a plurality of left-hand circular polarizers including a pair of substrates, a polyimide PI layer coated on one surface of each of the pair of the substrates, an anti-reflective AR layer coated on the other surface of each of the pair of the substrates, a plurality of spacers to secure a space between the polyimide PI layers, and a cholesteric liquid crystal CLC layer disposed on the space secured by the spacers and including a dextrorotary chiral material of a predetermined concentration; and
wherein the plurality of right-hand circular polarizers and left-hand circular polarizers are alternately placed at predetermined distances.

17. A filter comprising:
a plurality of right-hand circular polarizers including a cholesteric liquid crystal CLC layer including a levorotatory chiral material of a predetermined concentration;
a plurality of left-hand circular polarizers including a cholesteric liquid crystal CLC layer including a dextrorotatory chiral material of a predetermined concentration; and
an index matching material layer disposed between the plurality of right-hand circular polarizers and the left-hand circular polarizers, and
wherein the plurality of right-hand circular polarizers and left-hand circular polarizers are placed alternately, and
wherein the surfaces of the right-hand circular polarizers and the left-hand circular polarizers which are exposed to the outside are anti-reflective coated.

18. The filter of claim 16,
wherein the plurality of right-hand circular polarizers blocks light of a left-hand circular component of a predetermined frequency band among the light incident on the surface at a predetermined first angle, and
wherein the plurality of left-hand circular polarizer blocks light of a right-hand circular component of a predetermined frequency band among the light incident on the surface at a predetermined first angle and transmits light except for the blocked light of a left-hand circular component and of a right-hand circular component.

19. The filter of claim 16,
wherein the plurality of right-hand circular polarizers reflects light of a left-hand circular component of a predetermined frequency band among the light incident on the surface at a predetermined second angle,
wherein the plurality of left-hand circular polarizers reflects light of a right-hand circular component of a predetermined frequency band among the light incident on the surface at a predetermined second angle.

20. The filter of claim 17,
wherein the plurality of right-hand circular polarizers blocks light of a left-hand circular component of a predetermined frequency band among the light incident on the surface at a predetermined first angle, and
wherein the plurality of left-hand circular polarizer blocks light of a right-hand circular component of a predetermined frequency band among the light incident on the surface at a predetermined first angle and transmits light except for the blocked light of a left-hand circular component and of a right-hand circular component.

21. The filter of claim 17,
wherein the plurality of right-hand circular polarizers reflects light of a left-hand circular component of a predetermined frequency band among the light incident on the surface at a predetermined second angle,
wherein the plurality of left-hand circular polarizers reflects light of a right-hand circular component of a predetermined frequency band among the light incident on the surface at a predetermined second angle.
